(19) United States
(12) Patent Application Publication
(10) Pub. No.: US 2013/0042006 A1
(43) Pub. Date: Feb. 14, 2013

(54) STORAGE APPARATUS AND STORAGE MANAGEMENT METHOD

(71) Applicant: Mihoko MAEDA, Kawasaki (JP)

(72) Inventor: Mihoko MAEDA, Kawasaki (JP)

(73) Assignee: FUJITSU LIMITED, Kawasaki-shi (JP)

(21) Appl. No.: 13/568,173

(22) Filed: Aug. 7, 2012

(30) Foreign Application Priority Data
Aug. 12, 2011 (JP) 2011-176711

(51) Int. Cl. G06F 15/173

(52) U.S. Cl. 709/226

(57) ABSTRACT

In response to a resource allocation request which specifies an allocation destination group, a detection unit refers to a storage unit which stores information indicating resources having been individually allocated to one of multiple groups and information indicating whether each of the resources is in use. Subsequently, the detection unit detects an unused resource having been allocated to a group other than the allocation destination group. A setting unit makes a setting in the storage unit to cancel the allocation of the detected unused resource and reallocate the unused resource to the allocation destination group.

### CROSS-REFERENCE TO RELATED APPLICATION

This application is based upon and claims the benefit of priority of the prior Japanese Patent Application No. 2011-176711, filed on Aug. 12, 2011, the entire contents of which are incorporated herein by reference.

### FIELD

The embodiments discussed herein are related to a storage apparatus and a storage management method for managing a storage area by dividing the storage area into resources.

### BACKGROUND

A storage apparatus, such as a redundant array of inexpensive disks (RAID) device, is connected to a host computer. With this, many users are able to use the storage apparatus via the host computer. For example, one storage apparatus may be shared by multiple organizations (for example, departments and operation groups). In such a case, an administrator of each of the multiple organizations, which use the storage apparatus, manages the storage apparatus. However, when multiple administrators of the individual organizations manage the common storage apparatus, usual user authority management is not sufficient to prevent an administrator of a certain organization from deleting a volume of another organization and overwriting data. Deletion of a volume of another organization and data overwriting may be, for example, accidentally carried out by an administrator. Therefore, even when engaged in usual management operation, the administrators of the individual organizations carefully work with the greatest possible care to cause no effect on other organizations. Note however that the management of the storage apparatus becomes more difficult in proportion to the amount of resources (such as volumes) managed by the administrators. Therefore, solely depending on individual alertness of the administrators is insufficient to adequately prevent a situation like deletion of a volume caused by a mistake.

In view of the above, a “resource domain” technique for managing a storage apparatus has been proposed, which reduces the burden on the administrators. According to the resource domain technique, resources of the storage apparatus are divided into management units called “domains”. Then, each domain is managed as a virtual storage. In such a case, an administrator of each organization is able to implement management operations only on resources within a domain allocated to the organization. This allows a reduction of the workload of the administrator of each domain, and further provides security assurance for each domain.

One type of resources allocated to individual domains is RAID logical units (RLUs). RLUs are logical storage areas of RAID groups. For example, an overall administrator carries out an operation of creating RLUs for a storage apparatus and then performs RLU allocation to each domain. The overall administrator here is an administrator allowed to operate all resources, without being limited to a particular domain. Each domain is managed by a domain administrator. The domain administrator has a specified domain to manage and is able to perform operations only on RLUs allocated to the domain under the management. For example, the domain administrator divides an RLU allocated to the domain under its management into predetermined storage areas to thereby create smaller logical volumes. Hereinafter, each logical volume created by dividing an RLU is referred to as a host logical unit (OLU: open logical unit).

Note that creating logical volumes in the storage area of a storage apparatus imposes a burden on an operator. In view of this, the following storage system has been proposed, for example. The storage system requires an operator to input only minimum useful information. When receiving a logical unit (LU) setting command including the information, the storage system internally executes and completes processing using configuration management information regarding an LU and physical storage devices according to the LU setting command.

Japanese Laid-open Patent Publication No. 2010-86393

During operation of resource domains, there are cases where new RLUs need to be allocated to a domain, such as when the domain is newly added and when the domain requires more data storage area than originally expected. The simplest solution in such a case is to create RLUs by adding more disks and allocate the RLUs created with the use of the added disks to a domain requiring additional RLUs. Note however that installation of additional disks in the case where unused resources are sufficient in already existing resources reduces the use efficiency of resources. For example, in the case where unused RLUs exist in domains other than a domain requiring allocation of additional RLUs, the efficient use of resources is achieved if the unused RLUs can be allocated to the domain in need of additional RLUs.

However, RLUs having already been allocated to domains are managed by administrators of the individual domains, and it is difficult for the overall administrator of the storage apparatus to promptly determine usage status of each RLU. Therefore, it requires the overall administrator a lot of effort to find an RLU reallocatable to another domain. This problem becomes more prominent as the storage apparatus becomes larger in size. In addition, this problem is not limited only to allocation of RLUs to domains and is a general problem for storage apparatuses that carry out allocation of resources to groups for managing resources.

### SUMMARY

In one aspect of the embodiments, there is provided a storage apparatus for managing a storage area by dividing the storage area into resources. The storage apparatus includes: a memory configured to store information indicating whether each of the resources having been individually allocated to one of a plurality of groups is in use; and one or more processors configured to perform a procedure that includes, in response to a resource allocation request which specifies an allocation destination group, referring to the information stored in the memory and thereby detecting an unused resource having been allocated to a group other than the allocation destination group, and making a setting in the memory to cancel the allocation of the detected unused resource to the group other than the allocation destination group and reallocate the unused resource to the allocation destination group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional structure of an apparatus according to a first embodiment;

FIG. 2 is a flowchart illustrating an example of a resource allocation processing procedure according to the first embodiment;

FIG. 3 illustrates an example of the resource allocation processing according to the first embodiment;

FIG. 4 illustrates an example of a system configuration according to a second embodiment;

FIG. 5 illustrates an example of a hardware configuration of a storage apparatus used in the second embodiment;

FIG. 6 illustrates a management situation of RLUs;

FIG. 7 illustrates an example of information stored in a memory;

FIG. 8 illustrates an example of a data structure in a domain information storage area;

FIG. 9 illustrates an example of a data structure in an RLU information storage area;

FIG. 10 illustrates an example of a data structure in an OLU information storage area;

FIG. 11 is a first flowchart illustrating an example of an RLU allocation processing procedure;

FIG. 12 is a second flowchart illustrating the example of the RLU allocation processing procedure;

FIG. 13 is a third flowchart illustrating the example of the RLU allocation processing procedure;

FIG. 14 is a fourth flowchart illustrating the example of the RLU allocation processing procedure;

FIG. 15 illustrates an example of domain information;

FIG. 16 illustrates an example of RLU information;

FIG. 17 illustrates an RLU allocation situation;

FIG. 18 illustrates an example of selecting a first allocation candidate RLU;

FIG. 19 illustrates an example of RLU information obtained after the selection of the first allocation candidate;

FIG. 20 illustrates an example of selecting a second allocation candidate RLU;

FIG. 21 illustrates an example of RLU information obtained after the selection of the second allocation candidate;

FIG. 22 illustrates an example of selecting a third allocation candidate RLU;

FIG. 23 illustrates an example of RLU information obtained after the selection of the third allocation candidate;

FIG. 24 illustrates an example of allocating an RLU with an RLU number “0” to an allocation destination domain;

FIG. 25 illustrates an example of domain information obtained after the allocation of the RLU with the RLU number “0” to the allocation destination domain;

FIG. 26 illustrates an example of RLU information obtained after the allocation of the RLU with the RLU number “0” to the allocation destination domain;

FIG. 27 illustrates an example of transferring an OLU in an RLU with an RLU number “3”;

FIG. 28 illustrates an example of RLU information obtained after the transfer of the OLU in the RLU with the RLU number “3”;

FIG. 29 illustrates an example of allocating the RLU with the RLU number “3” to the allocation destination domain;

FIG. 30 illustrates an example of domain information obtained after the allocation of the RLU with the RLU number “3” to the allocation destination domain;

FIG. 31 illustrates an example of RLU information obtained after the allocation of the RLU with the RLU number “3” to the allocation destination domain;

FIG. 32 illustrates an example of allocating an RLU with an RLU number “4” to the allocation destination domain;

FIG. 33 illustrates an example of domain information obtained after the allocation of the RLU with the RLU number “4” to the allocation destination domain; and

FIG. 34 illustrates an example of RLU information obtained after the allocation of the RLU with the RLU number “4” to the allocation destination domain.

### DESCRIPTION OF EMBODIMENTS

Several embodiments will be described below with reference to the accompanying drawings, wherein like reference numerals refer to like elements throughout. Note that two or more of the embodiments may be combined for implementation in such a way that no contradiction arises.

### [a] First Embodiment

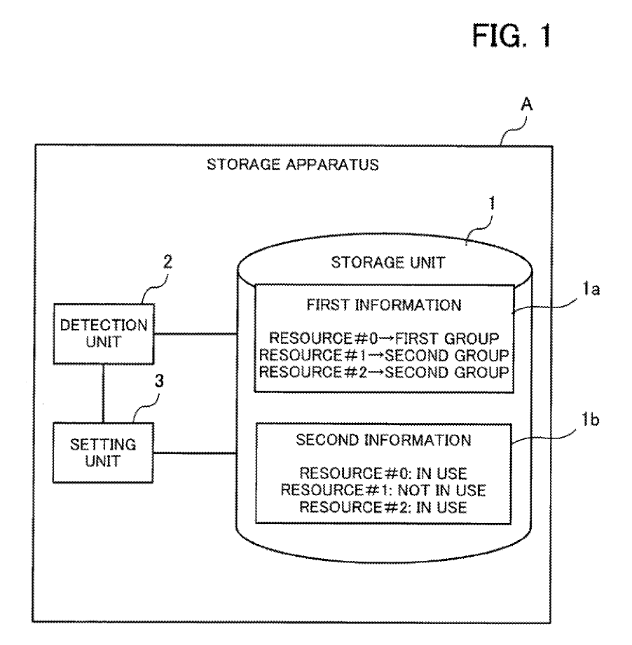

FIG. 1 illustrates an example of a functional structure of an apparatus according to a first embodiment. A storage apparatus A includes a storage unit 1, detection unit 2, and setting unit 3. The storage unit 1 stores resources individually allocated to one of multiple groups and information indicating whether each of the resources is in use. The resources are, for example, virtual disk volumes such as RAID groups. According to the example of FIG. 1, the storage unit 1 stores first information 1a indicating resources individually allocated to one of multiple groups and second information 1b indicating whether each of the resources is in use. For example, the first information 1a indicates that a resource with a resource number of “0” is allocated to a first group and resources with resource numbers of “1” and “2” are allocated to a second group. In addition, the second information 1b indicates that the resources with the resource numbers “0” and “2” are in use and the resource with the resource number “1” is not in use. For example, in the case where an administrator reserves an area for using a resource, the resource is set to be in use.

In response to a resource allocation request which specifies an allocation destination group, the detection unit 2 refers to the storage unit 1 and thereby detects an unused resource which has been allocated to a group other than the allocation destination group. For example, in the case where the first group is specified as an allocation destination group, the detection unit 2 detects, as an unused resource, the resource with the resource number “1”, which has been allocated to the second group but is not in use. The setting unit 3 makes a setting in the storage unit 1 to cancel the allocation of the detected unused resource to the group other than the allocation destination group and reallocate the unused resource to the allocation destination group. Note that the detection unit 2 and the setting unit 3 may be implemented by a central processing unit (CPU) of the storage apparatus A. In addition, the storage unit 1 may be implemented by a random access memory (RAM), a hard disk drive (HDD), a solid state drive (SSD) or the like of the storage apparatus A. Note that, in FIG. 1, each line connecting the individual components represents a part of communication paths, and communication paths other than those illustrated in FIG. 1 are also configurable.

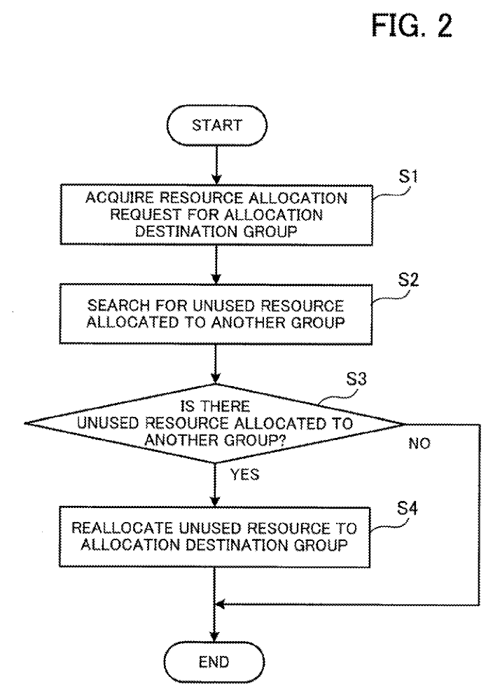

FIG. 2 is a flowchart illustrating an example of a resource allocation processing procedure according to the first embodiment. The processing of FIG. 2 is described next according to the step numbers.

[Step S1] The detection unit 2 acquires a resource allocation request which specifies an allocation destination group. Such a resource allocation request is input to the storage apparatus A from, for example, a Man-Machine Interface (MMI) of a terminal, or the like, connected to the storage apparatus A.

[Step S2] By referring to the storage unit 1, the detection unit 2 searches for an unused resource allocated to a group other than the specified allocation destination group.

[Step S3] The setting unit 3 determines whether at least one unused resource allocated to a group other than the specified allocation destination group has been detected by the detection unit 2. In the case where at least one unused resource has been detected, the setting unit 3 proceeds the processing to Step S4. On the other hand, when no unused resource is detected, the setting unit 3 ends the processing.

[Step S4] The setting unit 3 cancels the allocation of the unused resource to the other group and reallocates the unused resource to the specified allocation destination group.

In the above-described manner, it is possible to detect an unused resource out of resources having already been allocated to other groups and reallocate the unused resource to the allocation destination group.

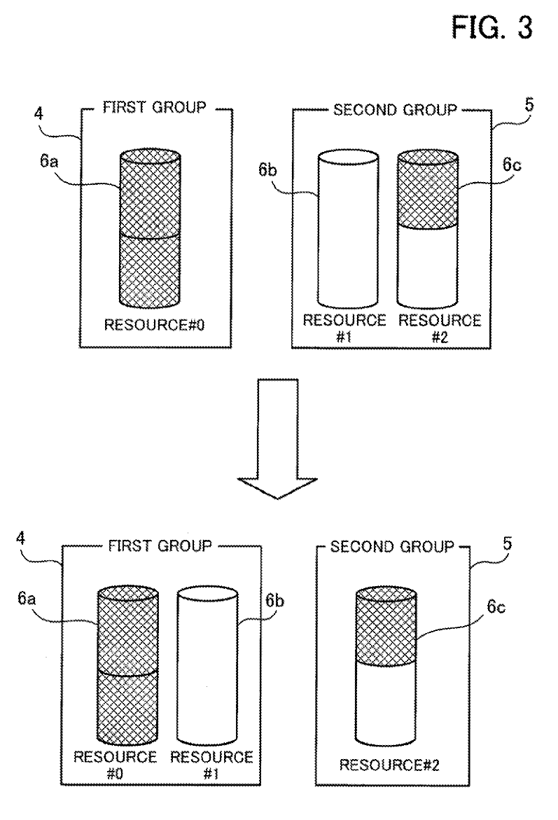

FIG. 3 illustrates an example of the resource allocation processing according to the first embodiment. According to the example of FIG. 3, a resource 6a with a resource number of “0” is allocated to a first group 4, and resources 6b and 6c with resource numbers of “1” and “2” are allocated to a second group 5. In FIG. 3, areas in use within the resources 6a, 6b, and 6c are indicated by shaded areas. In such a situation, if the first group 4 is scheduled to use a further resource, a resource allocation request which specifies the first group 4 as an allocation destination group is input to the storage apparatus A. In that case, in the storage apparatus A, a resource 6b which has been allocated to the second group 5 but is not in use is detected. Subsequently, in the storage apparatus A, the allocation of the detected resource 6b to the second group 5 is cancelled, and the resource 6b is newly allocated to the first group 4. Such allocation processing is automatically executed in the storage apparatus A, which saves the administrator the trouble of searching for an unused resource and facilitates the reallocation of a resource not used in one group to another group. That is, it is possible to easily achieve resource allocation that ensures the effective use of resources.

### [b] Second Embodiment

Next described is a second embodiment. The second embodiment enables easy allocation of RLUs to domains in a resource domain system. Note that domains of the resource domain system are one example of groups used for managing resources. In addition, RLUs allocated to the domains are one example of resources obtained by dividing the storage area of a storage apparatus.

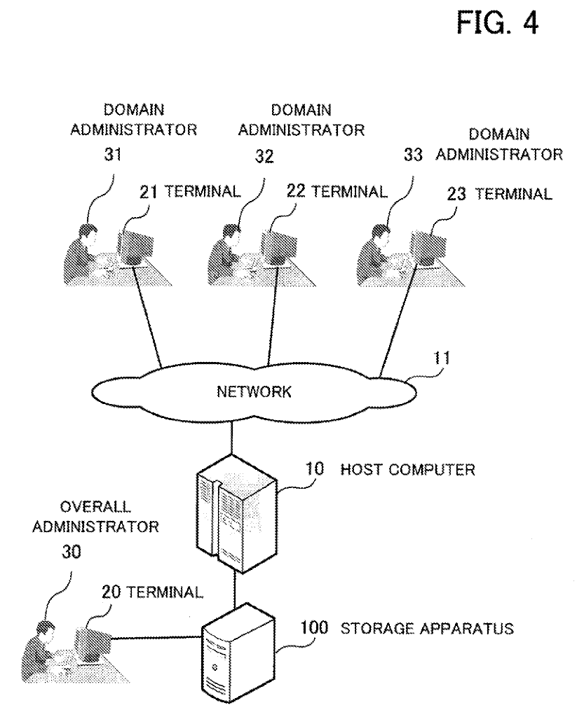

FIG. 4 illustrates an example of a system configuration according to the second embodiment. A storage apparatus 100 is a disk array apparatus using RAID technology. To the storage apparatus 100, a terminal 20 which is used by an overall administrator 30 is connected. The overall administrator 30 manages the whole storage apparatus 100 using the terminal 20. For example, using the terminal 20, the overall administrator 30 is able to input, to the storage apparatus 100, a request for expanding a resource allocated to a domain. In addition, a host computer 10 is also connected to the storage apparatus 100. To the host computer 10, multiple terminals 21 to 23 are connected via a network 11. The multiple terminals 21 to 23 are terminals used by domain administrators 31 to 33, respectively. The multiple domain administrators 31 to 33 use the terminals 21 to 23, respectively, to manage individual domains.

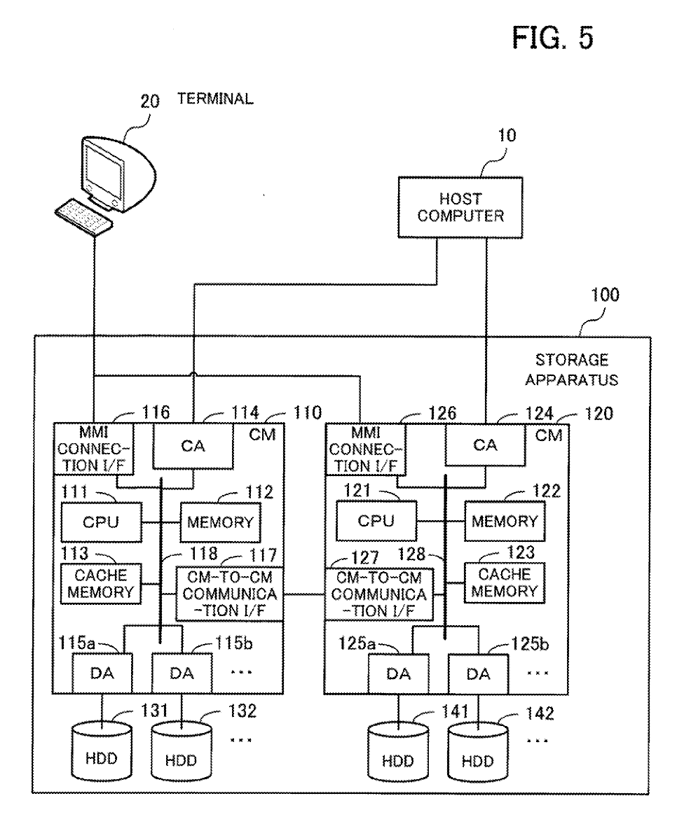

FIG. 5 illustrates an example of a hardware configuration of a storage apparatus used in the second embodiment. The storage apparatus 100 includes multiple controller modules (CMs) 110 and 120. The CMs 110 and 120 manage resources, such as physical disks, in the storage apparatus 100. For example, to the CM 110, hard disk drives (HDDs) 131, 132, . . . are connected. The CM 110 is in charge of managing resources (memory function) provided by the connected HDDs 131, 132, . . . . Also to the CM 120, HDDs 141, 142, . . . are connected. The CM 120 is in charge of managing resources (memory function) provided by the connected HDDs 141, 142, . . . . Each of the CMs 110 and 120 creates RAID groups by combining multiple HDDs under its management and causes the created RAID groups to function as RLUs. Note that the HDDs 131, 132, . . . , 141, 142, . . . may be replaced with SSDs.

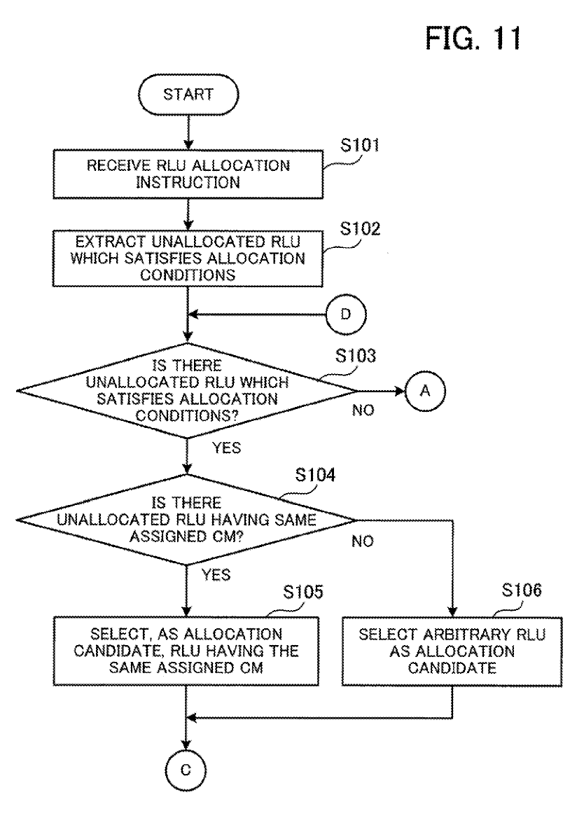

The CM 110 includes a CPU 111, a memory 112, a cache memory 113, a channel adapter (CA) 114, multiple device adapters (DAs) 115a, 115b, . . . , an MMI connection interface (I/F) 116, and a CM-to-CM communication I/F 117. The individual components of the CM 110 are connected to each other by an internal bus 118 of the CM 110. The CPU 111 controls the entire CM 110. For example, the CPU 111 performs a process of allocating RLUs to domains based on a program and data stored in the memory 112. The memory 112 stores various types of information used for the control of the CM 110. The memory 112 also stores a program in which processes to be executed by the CPU 111 are described. For example, a program causing the CPU 111 to execute processes illustrated in FIGS. 11 to 14 is stored in the memory 112. As the memory 112, a nonvolatile memory such as a flash memory may be used, for example. The cache memory 113 temporarily stores data to be input and output to and from the HDDs 131, 132, . . . . The CA 114 is an interface for performing communication using a fiber channel. The DAs 115a, 115b, . . . are connected to the HDDs, 131, 132, . . . , respectively, and input and output data to and from the connected HDDs. The MMI connection I/F 116 is an interface for providing connection to the terminal 20 which is used by the overall administrator 30. The CM-to-CM communication I/F 117 is an interface used for communication with another CM 120 of the storage apparatus 100. The CM-to-CM communication I/F 117 performs communication using, for example, PCI Express. Note that communication between the CMs 110 and 120 may be achieved via a relay circuit called a front-end router (FER). The CM 120 includes a CPU 121, a memory 122, a cache memory 123, a CA 124, multiple DAs 125a, 125b, . . . , an MMI connection I/F 126, and a CM-to-CM communication I/F 127. The individual components of the CM 120 having the same names as those of the CM 110 respectively have the same functions.

With the above-described hardware configuration, the processing function of the first embodiment is achieved. Note that the storage apparatus according to the first embodiment may be achieved by hardware similar to that of the storage apparatus 100 of FIG. 5. In that case, the functions of the detection unit 2 and the setting unit 3 of FIG. 1 are implemented by the CPUs 111 and 121 of the CMs 110 and 120 of FIG. 5. In addition, the function of the storage unit 1 of FIG. 1 is implemented by the memories 112 and 122 of the CMs 110 and 120 of FIG. 5. Note that the lines connecting the individual components of FIG. 5 represent part of communication channels, and communication channels other than those illustrated may be configurable.

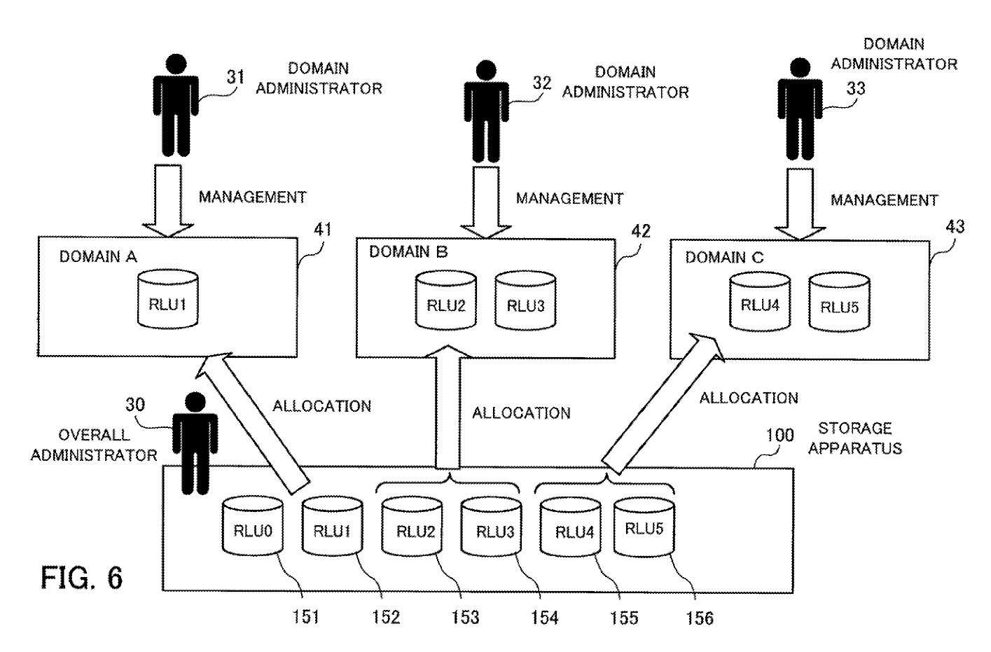

Next described is a management situation of RLUs in individual domains, which RLUs are generated in the storage apparatus 100. FIG. 6 illustrates a management situation of RLUs. According to the example of FIG. 6, six RLUs 151 to 156 are generated in the storage apparatus 100. The overall administrator 30 of the storage apparatus 100 carries out allocation of RLUs to domains. For example, in response to an instruction from the overall administrator 30, the storage apparatus 100 internally sets allocation of RLUs to domains. According to the example of FIG. 6, the RLU 152 with an RLU number “1” is allocated to a domain 41 having a domain name “A”. The RLUs 153 and 154 with RLU numbers “2” and “3”, respectively, are allocated to a domain 42 having a domain name “B”. The RLUs 155 and 156 with RLU numbers “4” and “5”, respectively, are allocated to a domain 43 having a domain name “C”. The domains 41 to 43 have dedicated domain administrators 31 to 33, respectively. For example, the domain administrator 31 is able to manage the domain 41 having the domain name “A”, however, is not able to manage the other domains 42 and 43. Similarly, the domain administrator 32 is able to manage the domain 42 having the domain name “B”, however, is not able to manage the other domains 41 and 43. Similarly, the domain administrator 33 is able to manage the domain 43 having the domain name “C”, however, is not able to manage the other domains 41 and 42.

Allocating RLUs to the domains in this manner allows the domain administrators 31 to 33, instead of the overall administrator 30, to perform RLU management operations. For example, it is possible to provide a domain with respect to each department of a company and allow a domain administrator of each department to manage RLUs used in the department. Furthermore, each domain administrator dealing with its own domain is not able to perform operations, such as setting operations, for other domains. This prevents the domain administrators from mistakenly performing manipulation on the domains of other departments.

In the case of storing data in an RLU, a logical volume (OLU) is created in the RLU based on, for example, an instruction from a domain administrator managing a domain to which the RLU has been allocated. Then, data input and output with a specified OLU is performed via the host computer 10.

Note that, in each assigned CM, RLUs to be handled by the CM are defined. At the time of access to data in an RLU, a cache memory of an assigned CM in charge of the RLU is used. Accordingly, in a resource domain environment, a system is established in such a manner that an assigned CM of each RLU to be allocated is different with respect to each domain. Herewith, each domain is less likely to be subject to the influence of data access made to other domains. In view of this, according to the second embodiment, at the time of RLU allocation to a domain, an RLU is preferentially allocated to the domain, which RLU has the same assigned CM as an RLU having already been allocated to the domain. Management information, such as RLU allocation of the storage apparatus 100 to domains and a situation of OLU creation in each RLU, is held in the memories 112 and 122 of the corresponding CMs 110 and 120, respectively.

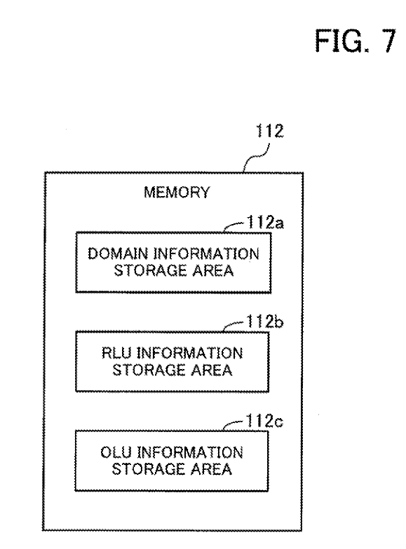

FIG. 7 illustrates an example of information stored in a memory. According to the example of FIG. 7, provided in the memory 112 are a domain information storage area 112a, an RLU information storage area 112b, and an OLU information storage area 112c. The domain information storage area 112a stores information related to domains. The RLU information storage area 112b stores information related to RLUs. The OLU information storage area 112c stores information related to OLUs.

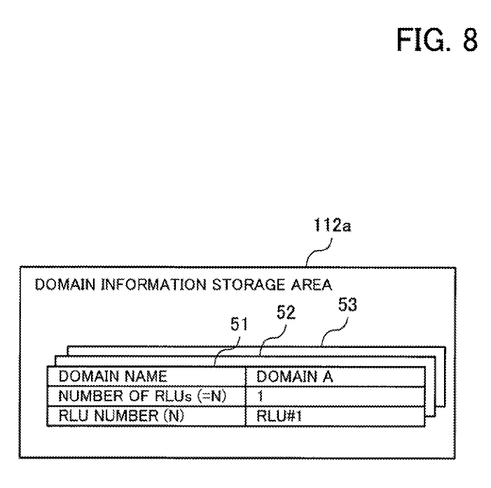

FIG. 8 illustrates an example of a data structure in a domain information storage area. The domain information storage area 112a stores domain information 51 to 53 for individual domains. Provided in each of the domain information 51 to 53 are fields of domain name, the number of RLUs allocated to the domain, and RLU number. In the field of the domain name, a name of a corresponding domain created in the storage apparatus 100 is set. In the field of the number of RLUs, the number of RLUs which have been allocated to a domain indicated by the corresponding domain name is set. In the field of RLU number, an identification number (RLU number) of one or more RLUs allocated to a domain indicated by the corresponding domain name is set. For example, in the case where the number of RLUs is N (N is an integer equal to or greater than zero), N RLU numbers are set in the field of RLU number.

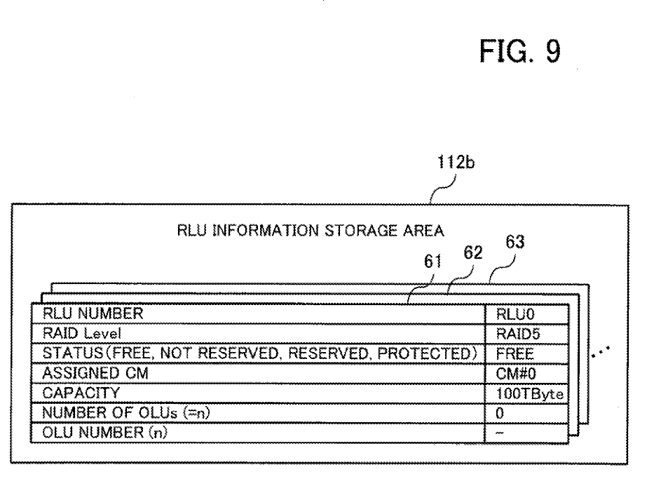

FIG. 9 illustrates an example of a data structure in an RLU information storage area. The RLU information storage area 112b stores RLU information 61, 62, 63, . . . for individual RLUs. Provided in each of the RLU information 61, 62, 63, . . . are fields of RLU number, RAID level, status, assigned CM, capacity, the number of OLUs, and OLU number. In the field of RLU number, an identification number (RLU number) of a corresponding RLU created in the storage apparatus 100 is set. In the field of RAID level, a RAID level of an RLU indicated by the corresponding RLU number is set. In the field of status, a status of an RLU indicated by the RLU number is set. There are four types of statuses: “Free”, “Not Reserved”, “Reserved”, and “Protected”. The status “Free” means that an RLU indicated by the RLU number is not allocated to any domain. The status “Not Reserved” means that an RLU indicated by the RLU number is allocated to a domain. The status “Reserved” means that an RLU indicated by the RLU number is a candidate of automatic allocation to a domain. The status “Protected” means that an RLU indicated by the RLU number is prohibited from being automatically allocated to a domain. In the field of assigned CM, an identification number of a CM which has been assigned to control an RLU indicated by the RLU number is set. In the field of capacity, storage capacity of an RLU indicated by the RLU number is set. In the field of the number of OLUs, the number of OLUs created in an RLU indicated by the RLU number is set. In the field of OLU number, an identification number (OLU number) of one or more OLUs created in an RLU indicated by the RLU number are set. For example, in the case where the number of OLUs is n (n is an integer equal to or greater than zero), n OLU numbers are set in the field of OLU number.

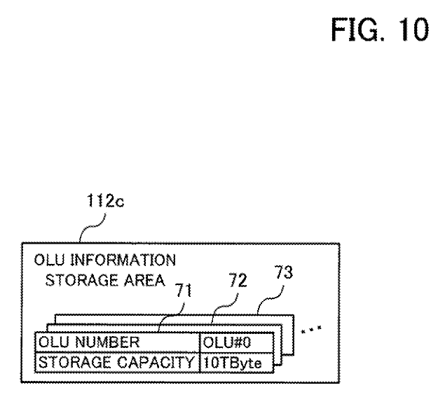

FIG. 10 illustrates an example of a data structure in the OLU information storage area. In the OLU information storage area 112c, OLU information 71, 72, 73, . . . for individual OLUs is stored. Provided in each of the OLU information 71, 72, 73, are fields of OLU number and storage capacity. In the field of OLU number, an identification number of a corresponding OLU is set. In the field of storage capacity, storage capacity of an OLU indicated by the OLU number is set. The storage apparatus 100 having the above-described configuration is capable of, in response to a domain expansion request for one domain, automatically selecting one or more RLUs to be additionally allocated to the domain and allocating the selected RLUs to the domain.

FIGS. 7 to 10 illustrate the internal structure of the memory 112 provided in the CM 110, however, the internal structure of the memory 122 provided in the other CM 120 is the same as that of the memory 112 of the CM 110. In addition, the individual CMs 110 and 120 periodically perform synchronous processing of information in the memories 112 and 122 so as to share the latest information. For example, when information in the memory 112 of the CM 110 is updated, the update content is reflected in the memory 122 of the CM 120 by synchronous processing. Note that a domain administrator is able to set in advance, via a user interface, whether each RLU allocated to a domain that the domain administrator manages is allowed to be reallocated to another domain. For example, for an RLU specified by the domain administrator as a reallocation-allowed RLU, the status in a corresponding piece of RLU information is set to “Not Reserved”. On the other hand, for an RLU specified by the domain administrator as a non-reallocation RLU, the status of a corresponding piece of RLU information is set to “Protected”.

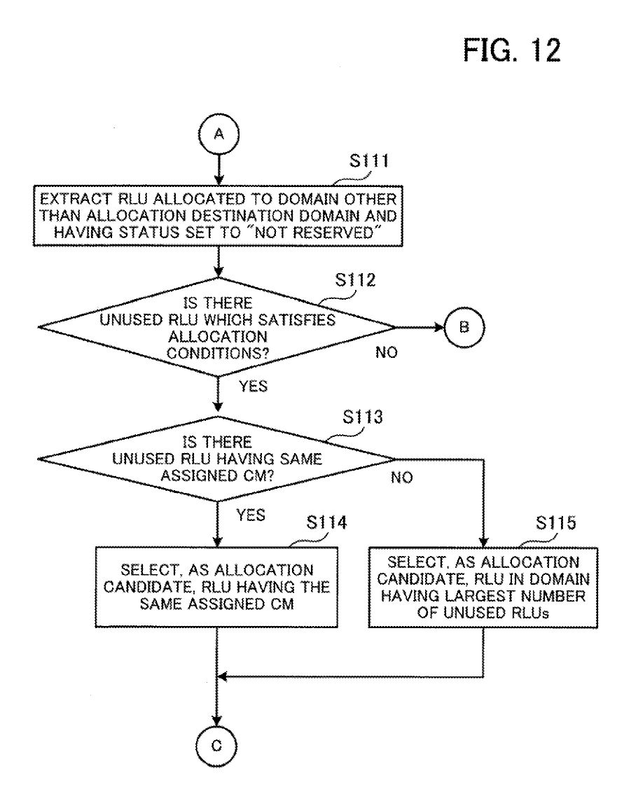

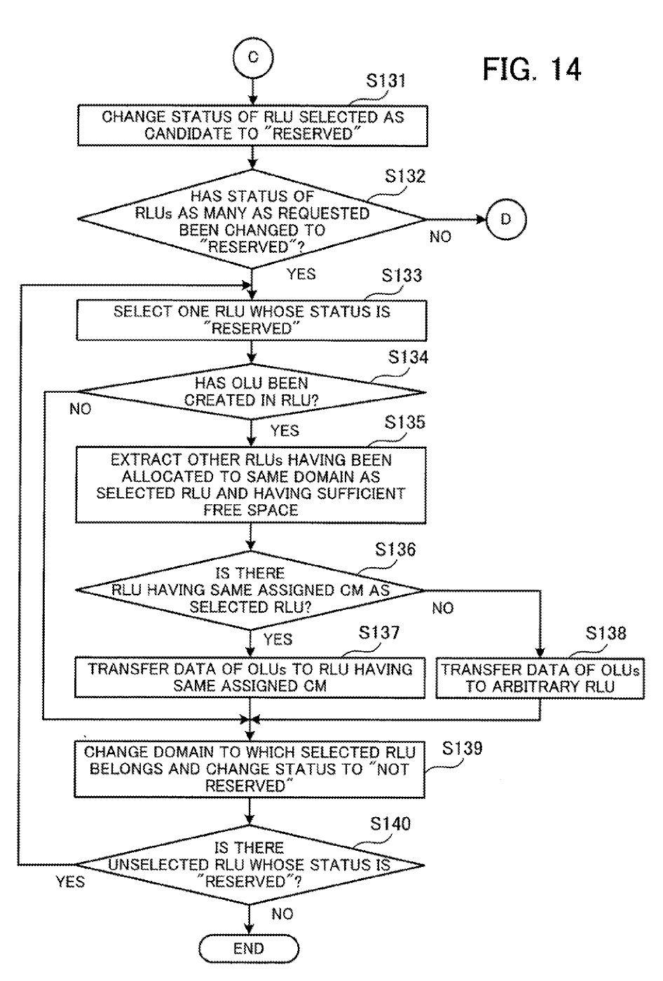

RLU allocation processing is described next in detail. Assume in the following example that the CM 110 performs RLU allocation processing and applies a result of the allocation to the other CM 120. FIG. 11 is a first flowchart illustrating an example of an RLU allocation processing procedure. The processing of FIG. 11 is described next according to the step numbers.

[Step S101] The CM 110 receives an input of a request for RLU allocation to a domain, which input is made, for example, by the overall administrator 30 using the terminal 20. Such an allocation request includes a domain name of a domain which is an allocation destination, the number of RLUs to be allocated, and conditions of one or more RLUs to be allocated (allocation conditions). The allocation conditions specify, for example, a RAID level and storage capacity of each RLU to be allocated.

[Step S102] The CM 110 determines whether there is an unallocated RLU which satisfies the allocation conditions. If there is one or more of such RLUs, the CM 110 extracts the RLUs. In this case, the CM 110 excludes, from extraction targets, RLUs prohibited from being automatically allocated to a domain. RLUs prohibited from being automatically allocated to a domain are those whose status in the corresponding pieces of RLU information is set to “Protected”. For example, the CPU 111 of the CM 110 refers to the RLU information storage area 112b in the memory 112, and searches for pieces of RLU information which satisfy the conditions regarding the RAID level and the storage capacity specified in the allocation request and have the status set to “Free”. Subsequently, the CPU 111 extracts an RLU number set in each piece of RLU information found in the search.

[Step S103] The CM 110 determines whether there is at least one unallocated RLU which satisfies the allocation conditions. For example, in the case where at least one RLU number is extracted in Step S102, there is at least one unallocated RLU which satisfies the allocation conditions. In the case where there is such an RLU, the CM 110 proceeds the processing to Step S104. On the other hand, when there is not such an RLU, the CM 110 proceeds the processing to Step S111 (see FIG. 12).

[Step S104] The CM 110 determines whether there is, among one or more unallocated RLUs which satisfy the allocation conditions, an RLU having the same assigned CM as an RLU having already been allocated to a domain which is the allocation destination. Note that a domain which is the allocation destination is referred to hereinafter as “allocation destination domain”. For example, the CPU 111 of the CM 110 refers to, in the domain information storage area 112a, a piece of domain information in which a domain name of the allocation destination domain is set, and acquires one or more RLU numbers set in the piece of domain information. The CPU 111 refers to, in the RLU information storage area 112b, one or more pieces of RLU information corresponding to the RLU numbers acquired from the piece of domain information, and acquires a CM number of an assigned CM from each of the pieces of RLU information. The one or more acquired CM numbers are specified as assigned CM numbers of the allocation destination domain. Further, the CPU 111 searches pieces of RLU information corresponding to the one or more RLU numbers extracted in Step S102 for a piece of RLU information whose CM number is the same as one of the assigned CM numbers of the allocation destination domain. If such a piece of RLU information is found in the search, the CPU 111 determines that there is an unallocated RLU having the same assigned CM as an RLU having already been allocated to the allocation destination domain. Note that in the case where no RLU has yet to be allocated to the allocation destination domain, the CPU 111 determines that there is no appropriate RLU. When there is an appropriate RLU, the CM 110 proceeds the processing to Step S105. On the other hand, when there is no appropriate RLU, the CM 110 proceeds the processing to Step S106.

[Step S105] Out of the one or more unallocated RLUs which satisfy the allocation conditions, the CM 110 selects, as an allocation candidate, one RLU having the same assigned CM as an RLU having already been allocated to the allocation destination domain. Subsequently, the CM 110 proceeds the processing to Step S131 (see FIG. 14).

[Step S106] Out of the one or more unallocated

RLUs which satisfy the allocation conditions, the CM 110 selects an arbitrary RLU as an allocation candidate. Subsequently, the CM 110 proceeds the processing to Step S131 (see FIG. 14).

According to the processes of Steps S103 to S106 of FIG. 11, if an unallocated RLU is found in the one or more RLUs which satisfy the allocation conditions, the unallocated RLU is given top priority to be selected as an allocation candidate. In the case where there are multiple unallocated RLUs which satisfy the allocation conditions, an RLU having a common assigned CM with an RLU having already been allocated to the allocation destination domain is preferentially selected from the multiple RLUs as an allocation candidate.

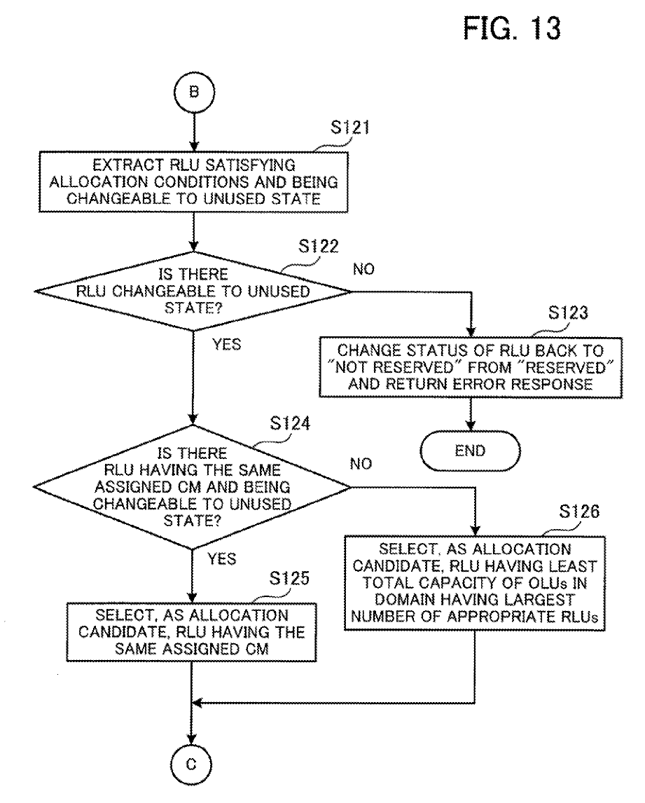

FIG. 12 is a second flowchart illustrating the example of the RLU allocation processing procedure. The processing of FIG. 12 is described next according to the step numbers.

[Step S111] In the case where there is no unallocated RLU which satisfies the allocation conditions, the CM 110 extracts, among one or more RLUs allocated to domains other than the allocation destination domain, one or more unused RLUs which satisfy the allocation conditions. At this point, the CM 110 excludes, from extraction targets, RLUs already selected as allocation candidates and RLUs prohibited from being automatically allocated to a domain. For example, the CPU 111 of the CM 110 refers to, in the domain information storage area 112a, a piece of domain information corresponding to the allocation destination domain, and extracts each RLU number of one or more RLUs allocated to the domain. Subsequently, the CPU 111 refers to, in the RLU information storage area 112b, pieces of RLU information whose RLU number is other than the extracted one or more RLU numbers, and searches for one or more unused RLUs which satisfy the allocation conditions and have the status set to “Not Reserved”. Whether an RLU is unused may be determined, for example, by the presence or absence of one or more OLUs. That is, the CPU 111 determines that an RLU is unused if no OLU has been created in the RLU. Whether one or more OLUs have been created in the RLU may be determined by the value in the field of the number of OLUs in the corresponding piece of RLU information. In the case where the number of OLUs in the piece of RLU information is “0”, no OLU has been created in an RLU corresponding to the piece of RLU information.

[Step S112] The CM 110 determines whether there is at least one unused RLU which satisfies the allocation conditions. For example, in the case where at least one RLU is extracted in Step S111, there is at least one unused RLU which satisfies the allocation conditions. In the case where there is such an RLU, the CM 110 proceeds the processing to Step S113. On the other hand, when there is not such an RLU, the CM 110 proceeds the processing to Step S121 (see FIG. 13).

[Step S113] The CM 110 determines whether there is, among the one or more unused RLUs which satisfy the allocation conditions, an RLU having the same assigned CM as an RLU having already been allocated to the allocation destination domain. For example, the CPU 111 of the CM 110 refers to, in the domain information storage area 112a, a piece of domain information in which a domain name of the allocation destination domain is set, and acquires one or more RLU numbers set in the piece of domain information. The CPU 111 refers to, in the RLU information storage area 112b, one or more pieces of RLU information corresponding to the RLU numbers acquired from the piece of domain information, and acquires a CM number of an assigned CM from each of the pieces of RLU information. The one or more acquired CM numbers are specified as assigned CM numbers of the allocation destination domain. Further, the CPU 111 searches pieces of RLU information corresponding to the one or more RLU numbers extracted in Step S111 for a piece of RLU information whose CM number is the same as one of the assigned CM numbers of the allocation destination domain. If such a piece of RLU information is found in the search, the CPU 111 determines that there is an unused RLU having the same assigned CM as an RLU having already been allocated to the allocation destination domain. Note that in the case where no RLU has yet to be allocated to the allocation destination domain, the CPU 111 determines that there is no appropriate RLU. When there is an appropriate RLU, the CM 110 proceeds the processing to Step S114. On the other hand, when there is no appropriate RLU, the CM 110 proceeds the processing to Step S115.

[Step S114] Out of the one or more unused RLUs which satisfy the allocation conditions, the CM 110 selects, as an allocation candidate, one RLU having the same assigned CM as an RLU having already been allocated to the allocation destination domain. Subsequently, the CM 110 proceeds the processing to Step S131 (see FIG. 14).

[Step S115] Out of the one or more unused RLUs which satisfy the allocation conditions, the CM 110 selects, as an allocation candidate, one RLU having been allocated to a domain which has the largest number of unused RLUs. Subsequently, the CM 110 proceeds the processing to Step S131 (see FIG. 14).

According to the processes of Steps S111 to S115 of FIG. 12, in the case where there is no unallocated RLU which satisfies the allocation conditions, an unused RLU which satisfies the allocation conditions is preferentially selected as an allocation candidate. In addition, in the case where there are multiple unused RLUs which satisfy the allocation conditions, an RLU having a common assigned CM with an RLU having already been allocated to the allocation destination domain is preferentially selected from the multiple RLUs as an allocation candidate.

FIG. 13 is a third flowchart illustrating the is example of the RLU allocation processing procedure. The processing of FIG. 13 is described next according to the step numbers.

[Step S121] The CM 110 extracts, out of RLUs allocated to domains other than the allocation destination domain, an RLU which satisfies the allocation conditions and can be changed to an unused state. At this point, the CM 110 excludes, from extraction targets, RLUs already selected as allocation candidates and RLUs prohibited from being automatically allocated to a domain. For example, with respect to each domain other than the allocation destination domain, the CPU 111 of the CM 110 refers to a piece of RLU information corresponding each of one or more RLUs allocated to the domain. Subsequently, the CPU 111 searches each domain to see whether there is an RLU which has the status set to “Not Reserved”, satisfies the allocation conditions, and further has capacity equal to or less than capacity obtained by the following Expression (1). Note that the allocation conditions are conditions related to, for example, a RAID level and capacity.

[Total Capacity of RLUs Allocated to a Domain]−[Total Capacity of OLUs in the Domain] (1)

Expression (1) indicates the total amount of unused area in all RLUs allocated to the domain. That is, an RLU having capacity equal to or less than the capacity obtained from Expression (1) can be changed to an unused state by transferring OLUs created in the RLU to another RLU. Note that, the [Total Capacity of RLUs Allocated to a Domain] is obtained based on corresponding pieces of domain and RLU information. For example, the CPU 111 sequentially selects pieces of domain information stored in the domain information storage area 112a. Subsequently, the CPU 111 acquires, among RLU numbers set in the selected pieces of domain information, RLU numbers of RLUs other than those already selected as allocation candidates. The CPU 111 refers to, in the RLU information storage area 112b, pieces of RLU information corresponding to the acquired RLU numbers, and adds together capacity set in the referred pieces of RLU information. A value obtained by the addition is the [Total Capacity of RLUs Allocated to a Domain] corresponding to the piece of domain information. In addition, the [Total Capacity of OLUs in the Domain] is obtained based on corresponding pieces of domain, RLU, and OLU information. For example, the CPU 111 sequentially selects each piece of domain information stored in the domain information storage area 112a. Subsequently, the CPU 111 acquires one or more RLU numbers set in the selected piece of domain information. The CPU 111 refers to, in the RLU information storage area 112b, pieces of RLU information corresponding to the acquired RLU numbers, and acquires one or more OLU numbers set in each of the referred pieces of RLU information. The CPU 111 refers to, in the OLU information storage area 112c, pieces of OLU information corresponding to the acquired OLU numbers, and adds together storage capacity set in the referred pieces of OLU information. A value obtained by the addition is the [Total Capacity of OLUs in the Domain].

An RLU satisfying the allocation conditions and having storage capacity equal to or less than the capacity obtained from Expression (1) is obtained based on a search result obtained according to Expression (1), and pieces of domain and RLU information. For example, the CPU 111 acquires one or more RLU numbers from a piece of domain information of each domain used in the calculation of Expression (1), which domain information is stored in the domain information storage area 112a. Subsequently, the CPU 111 searches pieces of RLU information stored in the RLU information storage area 112b and corresponding to the acquired RLU numbers for a piece of RLU information in which capacity equal to or less than the capacity obtained from Expression (1) is set. Then, the CPU 111 acquires, as a search result, an RLU number set in an appropriate piece of RLU information found in the search. When detecting an RLU satisfying the allocation conditions and having capacity equal to or less than the capacity obtained from Expression (1), the CPU 111 specifies the detected RLU as an RLU changeable to an unused state. In addition, the CM 110 calculates, with respect to each domain, the number of RLUs changeable to an unused state. For example, in the case where one or more RLUs changeable to an unused state are obtained in one domain, the CPU 111 of the CM 110 recalculates capacity using Expression (1) by excluding one of the RLUs changeable to an unused state. In the recalculation, the excluded RLU is treated as not being allocated to the domain. That is, in the recalculation, the sum of capacity of RLUs except for the excluded RLU is the [Total Capacity of RLUs Allocated to the Domain]. Note that, as for the [Total Capacity of OLUs in the Domain], the same value as in the first calculation is used in the recalculation. Based on the recalculated capacity, the CPU 111 performs a further search for an RLU satisfying the allocation conditions and having capacity equal to or less than the capacity obtained from Expression (1). In the case where one or more such RLUs are detected, the CPU 111 recalculates capacity using Expression (1) by further excluding one of the detected RLUs and searches for one or more RLUs having capacity equal to or less than the capacity obtained from Expression (1). The CPU 111 repeats the search until such an RLU is no more detected. Subsequently, the CPU 111 specifies the number of RLUs excluded by the time such an RLU is no more detected as the number of RLUs of the domain, which are changeable to an unused state. As a result of the process of Step S121, a list of RLUs changeable to an unused state in a domain and the number of RLUs changeable to an unused state are obtained with respect to each domain.

[Step S122] The CM 110 determines whether there is at least one RLU changeable to an unused state in any domain. In the case where there is such an RLU, the CM 110 proceeds the processing to Step S124. On the other hand, when there is no such an RLU, the CM 110 proceeds the processing to Step S123.

[Step S123] The CM 110 determines that the number of RLUs specified in the allocation request may not be allocated and cancels the selection of one or more RLUs which have been selected as allocation candidates. Then, the CM 110 returns an error in response to the allocation request. For example, the CPU 111 of the CM 110 checks the status in each piece of RLU information stored in the RLU information storage area 112b, and changes the status to “Not Reserved” in the case where the status is “Reserved”. With this, the selection of RLUs as allocation candidates is canceled. Subsequently, the CPU 111 outputs an error message to, for example, the terminal 20 used by the overall administrator 30. Subsequently, the process is ended.

[Step S124] In the case where there is one or more RLUs changeable to an unused state, the CM 110 determines whether there is one or more RLUs changeable to an unused state, which RLUs have the same assigned CM as an RLU having already been allocated to the allocation destination domain. For example, the CPU 111 of the CM 110 refers to, in the domain information storage area 112a, a piece of domain information in which a domain name of the allocation destination domain is set, and acquires one or more RLU numbers set in the piece of domain information. The CPU 111 refers to, in the RLU information storage area 112b, one or more pieces of RLU information corresponding to the RLU numbers acquired from the piece of domain information, and acquires a CM number of an assigned CM from each of the pieces of RLU information. The one or more acquired CM numbers are specified as assigned CM numbers of the allocation destination domain. Further, the CPU 111 searches pieces of RLU information corresponding to the one or more RLU numbers extracted in Step S121 for a piece of RLU information whose CM number is the same as one of the assigned CM numbers of the allocation destination domain. If such a piece of RLU information is found in the search, the CPU 111 determines that there is an RLU having the same assigned CM as an RLU having already been allocated to the allocation destination domain and being changeable to an unused state. Note that in the case where no RLU has yet to be allocated to the allocation destination domain, the CPU 111 determines that there is no appropriate RLU. When there is an appropriate RLU, the CM 110 proceeds the processing to Step S125. On the other hand, when there is no appropriate RLU, the CM 110 proceeds the processing to Step S126.

[Step S125] Out of the one or more RLUs satisfying the allocation conditions and being changeable to an unused state, the CM 110 selects, as an allocation candidate, one RLU having the same assigned CM as an RLU having already been allocated to the allocation destination domain. Subsequently, the CM 110 proceeds the processing to Step S131 (see FIG. 14).

[Step S126] Out of the one or more RLUs satisfying the allocation conditions and being changeable to an unused state, the CM 110 selects, as an allocation candidate, one RLU having the least influence on a corresponding domain when the RLU is changed to an unused state. For example, the CPU 111 of the CM 110 compares domains in terms of the number of RLUs changeable to an unused state, which number is obtained in Step S121, and determines a domain having the largest number of such RLUs. Subsequently, out of the RLUs of the determined domain, which RLUs are extracted in Step S121, the CM 110 selects, as an allocation candidate, an RLU having the least total capacity of OLUs having been created. Note that the total capacity of OLUs having been created in an RLU is determined based on corresponding pieces of RLU and OLU information. For example, the CPU 111 selects one RLU extracted in Step S121. Subsequently, the CPU 111 acquires one or more OLU numbers from a piece of RLU information corresponding to the selected RLU. Then, the CPU 111 refers to, in the OLU information storage area 112c, pieces of OLU information corresponding to the acquired OLU numbers, and adds together storage capacity set in the referred pieces of OLU information. A value obtained by the addition is the total capacity of OLUs having been created in the RLU. Subsequently, the CM 110 proceeds the processing to Step S131 (see FIG. 14).

FIG. 13 illustrates the processing performed when there is an unallocated RLU satisfying the allocation conditions and the processing performed when there is no unallocated RLU satisfying the allocation conditions. In this case, a search for an RLU changeable to an unused state is performed, and if such an RLU is found, the RLU is selected as an allocation candidate. In the case where there are multiple RLUs changeable to an unused state, an RLU having a common assigned CM with an RLU having already been allocated to the allocation destination domain is preferentially selected as an allocation candidate out of the multiple RLUs. If there is no RLU having a common assigned CM with an RLU having already been allocated to the allocation destination domain, an RLU requiring the least data copying among RLUs having been allocated to a domain which has the largest available capacity is selected as an allocation candidate.

FIG. 14 is a fourth flowchart illustrating the example of the RLU allocation processing procedure. The processing of FIG. 14 is described next according to the step numbers.

[Step S131] The CM 110 changes the status of the RLU selected as an allocation candidate to “Reserved”. For example, the CPU 111 of the CM 110 specifies, in the RLU information storage area 112b, a piece of RLU information corresponding to the RLU selected as an allocation candidate in any one of Steps S105, S106, S114, S115, S125, and S126. Subsequently, the CPU 111 changes the status of the specified piece of RLU information to “Reserved”.

[Step S132] The CM 110 determines whether the status of RLUs as many as specified in the allocation request has been changed to “Reserved”. In the case where the number of RLUs whose status has been changed to “Reserved” has reached the requested number, the CM 110 proceeds the processing to Step S133. On the other hand, when the number of RLUs whose status has been changed to “Reserved” has yet to reach the requested number, the CM 110 proceeds the processing to Step S103 (see FIG. 11).

[Step S133] The CM 110 selects, among one or more RLUs whose status has been changed to “Reserved”, one RLU which has yet to go through the processing of Steps S134 to S140. For example, the CPU 111 of the CM 110 sequentially selects, out of pieces of RLU information stored in the RLU information storage area 112b, pieces of RLU information whose status is “Reserved” in ascending order of the RLU numbers.

[Step S134] The CM 110 determines whether one or more OLUs have been created in the selected RLU. For example, the CPU 111 of the CM 110 acquires the number of OLUs set in a piece of RLU information corresponding to the selected RLU. If the acquired number of OLUs is “0”, the CPU 111 determines that no OLU has been created in the selected RLU. On the other hand, if the acquired number of OLUs is 1 or greater, the CPU 111 determines that one or more OLUs have been created in the selected RLU. In the case where one or more OLUs have been created, the CPU 111 proceeds the process to Step S135. On the other hand, when no OLU has been created, the CPU 111 proceeds the process to Step S139.

[Step S135] The CM 110 extracts, as an OLU-transfer destination candidate, a different RLU which has been allocated to the same domain as the selected RLU and has sufficient free space. For example, the CPU 111 of the CM 110 specifies, out of pieces of domain information stored in the domain information storage area 112a, a piece of domain information which has an RLU number of the selected RLU. The CPU 111 acquires, out of RLU numbers set in the specified piece of domain information, an RLU number corresponding to each of one or more RLUs other than the selected RLU. Subsequently, the CPU 111 refers to, in the RLU information storage area 112b, a piece of RLU information corresponding to each of the acquired RLU numbers, and calculates free space of an RLU indicated in each piece of RLU information. The free space is obtained by subtracting the total capacity of OLUs having been created in each RLU from the RLU capacity. For example, the CPU 111 extracts, as OLU-transfer destination candidates, all RLUs having larger free space than the capacity of OLUs having been created in the selected RLU.

[Step S136] Out of the RLUs extracted as OLU-transfer destination candidates, the CM 110 determines whether there is an RLU having the same assigned CM as the selected RLU. If there is such an RLU, the CM 110 proceeds the process to Step S137. On the other hand, if there is no such an RLU, the CM 110 proceeds the process to Step S138.

[Step S137] The CM 110 transfers data of the selected RLU to the RLU found in Step S136 (that is, an OLU-transfer destination RLU). For example, the CPU 111 of the CM 110 creates, in the OLU-transfer destination RLU, OLUs having the same capacity as that of OLUs in the selected RLU. Subsequently, the CPU 111 copies data of the OLUs in the selected RLU to the OLUs created in the OLU-transfer destination RLU. Subsequently, the CPU 111 deletes the OLUs from the selected RLU. The CM 110 then proceeds the processing to Step S139.

[Step S138] The CM 110 transfers data of the selected RLU to an RLU arbitrarily selected from the RLUs being OLU-transfer destination candidates. A specific example of the data transfer processing is the same as in Step S137.

[Step S139] The CM 110 changes the domain of the selected RLU to the allocation destination domain specified in the allocation request, and changes the state of the RLU from “an allocation candidate” to “having been allocated”. For example, the CPU 111 of the CM 110 deletes the RLU number of the selected RLU from a piece of domain information corresponding to the domain to which the selected RLU used to belong. In addition, the CPU 111 adds the RLU number of the selected RLU to a piece of domain information corresponding to the allocation destination domain. Further, the CPU 111 changes the status of the piece of RLU information corresponding to the selected RLU to “Not Reserved”.

[Step S140] The CM 110 determines whether there is one or more unselected RLUs whose status is “Reserved”. For example, in the case of sequentially selecting, in Step S133, pieces of RLU information whose status is “Reserved” in ascending order of the RLU numbers, the CPU 111 of the CM 110 determines whether there is an RLU, which has a status set to “Reserved”, whose RLU number is larger than the RLU number of the latest selected RLU. In the case where there is such an RLU, the CPU 111 determines that there is an unselected RLU whose status is “Reserved”. If there is an unselected RLU, the CM 110 proceeds the processing to Step S133. On the other hand, if there is no unselected RLU, the CM 110 ends the processing.

According to the processes of Steps S133 to S140 of FIG. 14, RLUs as many as specified in the allocation request are allocated to the allocation destination domain. At this point, as for each RLU in which one or more OLUs have already been created, data in the OLUs is transferred to another RLU having been allocated to the same domain as the RLU, and then, the RLU is allocated to the allocation destination domain. With regard to the data transfer, an RLU having the same assigned CM as the transfer source RLU is preferentially selected as the data transfer destination RLU.

As described above, the processing of FIGS. 11 to 14 is automatically performed inside the storage apparatus 100, which facilitates addition of RLUs to a domain and enables a reduction in the number of processing operations of the overall administrator.

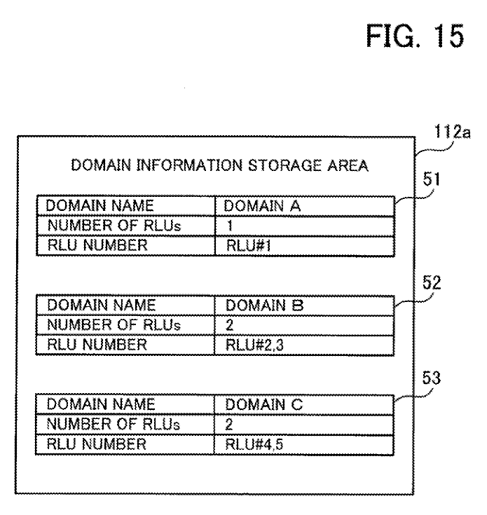

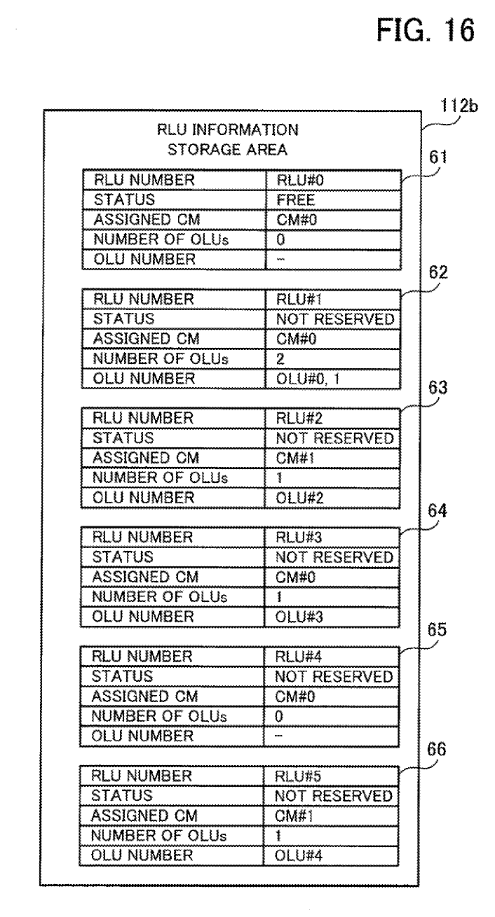

Next described is a specific example of RLU allocation. FIGS. 15 and 16 illustrate examples of domain information and RLU information, respectively, before the start of the RLU allocation processing. FIG. 15 illustrates an example of domain information. According to the example of FIG. 15, three pieces of domain information 51 to 53 are stored in the domain information storage area 112a. One RLU with an RLU number “1” is allocated to a domain having a domain name “A”. Two RLUs with RLU numbers “2” and “3” are allocated to a domain having a domain name “B”. Two RLUs with RLU numbers “4” and “5” are allocated to a domain having a domain name “C”.

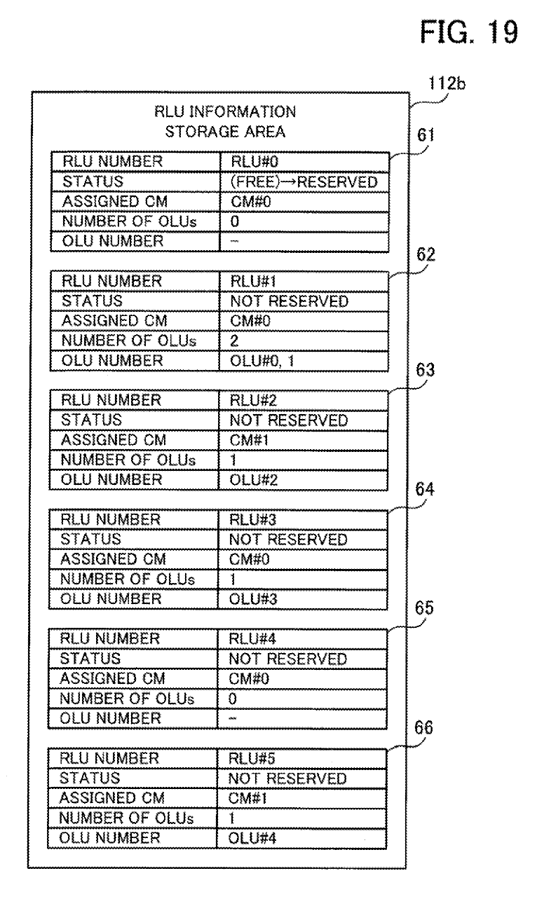

FIG. 16 illustrates an example of RLU information. According to the example of FIG. 16, six RLU information 61 to 66 are stored in the RLU information storage area 112b. Note that, in FIG. 16, the fields of “RAID level” and “capacity” are omitted from the individual RLU information 61 to 66. Similarly, the fields of “RAID level” and “capacity” are omitted in FIGS. 19, 21, 23, 26, 28, 31, and 34. As for an RLU with an RLU number “0”, the status is “Free” and the CM number of an assigned CM is “0”. As for an RLU with an RLU number “1”, the status is “Not Reserved”, the CM number of an assigned CM is “0”, and two OLUs with OLU numbers of “0” and “1” are included. As for an RLU with an RLU number “2”, the status is “Not Reserved”, the CM number of an assigned CM is “1”, and one OLU with an OLU number of “2” is included. As for an RLU with an RLU number “3”, the status is “Not Reserved”, the CM number of an assigned CM is “0”, and one OLU with an OLU number of “3” is included. As for an RLU with an RLU number “4”, the status is “Not Reserved”, the CM number of an assigned CM is “0”, and there is no OLU. As for an RLU with an RLU number “5”, the status is “Not Reserved”, the CM number of an assigned CM is “1”, and one OLU with an OLU number of “4” is included.

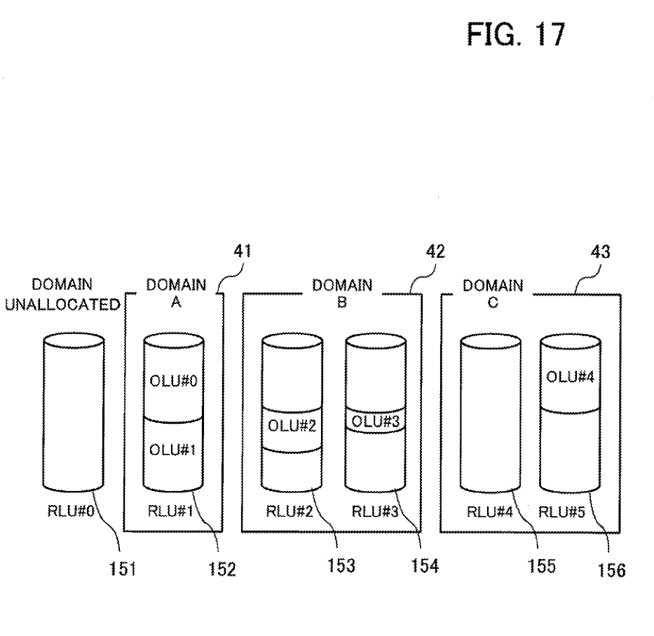

FIG. 17 illustrates an RLU allocation situation. As illustrated in FIG. 17, RLUs are allocated to the three domains 41 to 43. Here, the entire storage capacity of the RLU 152 allocated to the domain 41 is used by OLUs. Therefore, in this situation, an organization using the domain 41 is not able to create a new OLU. In the case where the amount of information to be dealt with in the organization using the domain 41 is expected to increase, the storage capacity of the domain 41 needs to be expanded. Assume in the following example that three RLUs are to be newly added to the domain 41. In that case, for example, the overall administrator 30 inputs, to the storage apparatus 100 using the terminal 20, a request for allocating three RLUs to the domain 41, which is specified as an allocation destination in the request. At this point, the overall administrator 30 is able to specify a RAID level and storage capacity as allocation conditions. Assume in this example that all the RLUs 151 to 156 illustrated in FIG. 17 satisfy allocation conditions. In the storage apparatus 100 after receiving the allocation request, RLUs to be allocation candidates are selected.

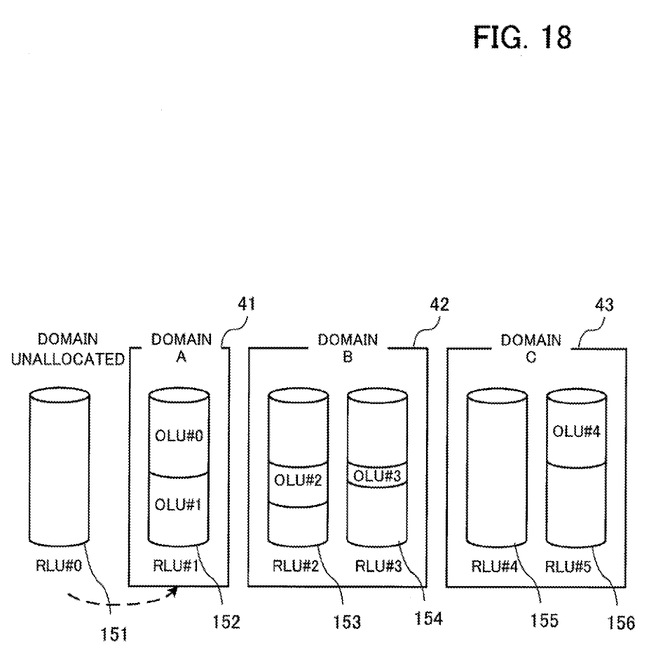

FIG. 18 illustrates an example of selecting a first allocation candidate RLU. An unallocated RLU has the highest priority as an allocation candidate. Accordingly, as illustrated in FIG. 18, the RLU 151 is selected as the first allocation candidate. When the RLU 151 is selected as an allocation candidate, a piece of RLU information corresponding to the selected RLU 151 is updated.

FIG. 19 illustrates an example of RLU information obtained after the selection of the first allocation candidate. According to the example of FIG. 19, because the RLU 151 with the RLU number “0” is selected as an allocation candidate, the status of the corresponding RLU information 61 is changed to “Reserved”.

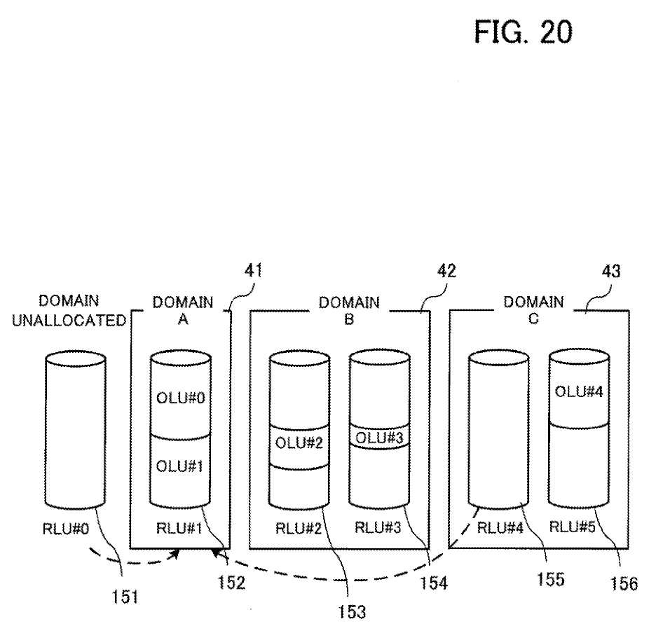

FIG. 20 illustrates an example of selecting a second allocation candidate RLU. As illustrated in FIG. 20, there is only one unallocated RLU. Therefore, an RLU which has been allocated to another domain but is not in use (unused RLU) is preferentially selected as the second allocation candidate. According to the example of FIG. 20, the RLU 155 having been allocated to the domain 43 is not in use. Accordingly, the RLU 155 is selected as the second allocation candidate.

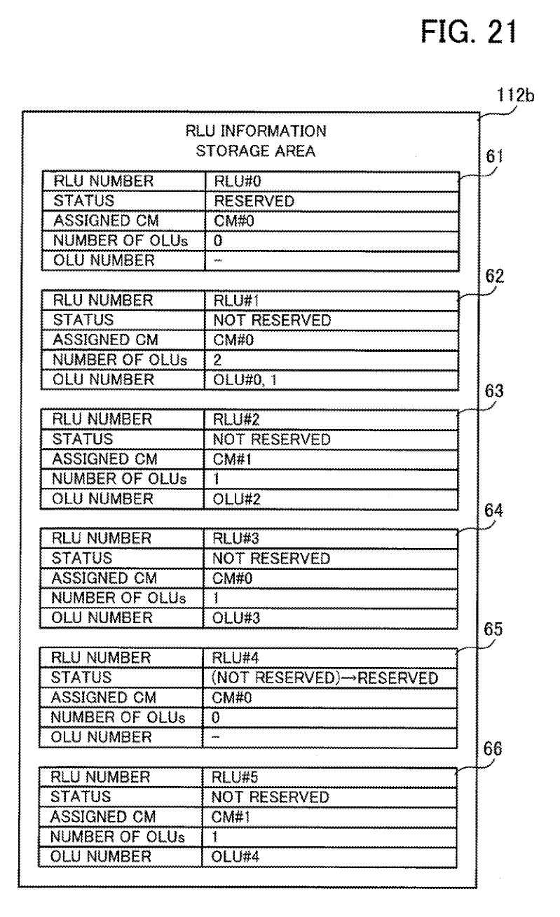

FIG. 21 illustrates an example of RLU information obtained after the selection of the second allocation candidate. According to the example of FIG. 21, because the RLU 155 with the RLU number “4” is selected as an allocation candidate, the status of the corresponding RLU information 65 is changed to “Reserved”.

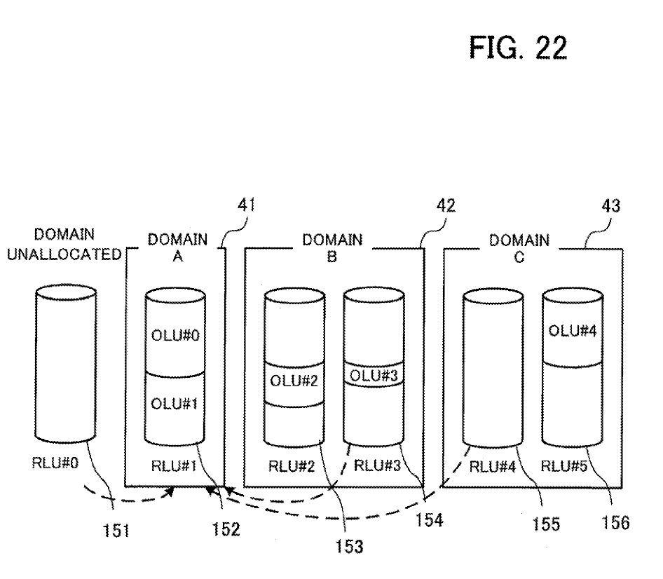

FIG. 22 illustrates an example of selecting a third allocation candidate RLU. As illustrated in FIG. 22, there are neither unallocated nor unused RLUs other than the RLUs 151 and 155 which have already been selected as allocation candidates. Accordingly, an RLU changeable to an unused state is searched for among RLUs each of which has already been allocated to one of other domains. According to the example of FIG. 22, it is possible to, in the domain 42, bring OLUs of the RLUs 153 and 154 together into either one of the RLUs 153 and 154. In this case, both of the two RLUs 153 and 154 are changeable to an unused state. However, since only one of the RLUs 153 and 154 is allowed to be changed to an unused state in the domain 42, the number of RLUs allowed to be changed to an unused state in the domain 42 is “1”. As for the domain 43, the RLU 155 has already been selected as an allocation candidate. Therefore, it is not possible to change the RLU 153 to an unused state. Accordingly, there is no RLU changeable to an unused state in the domain 43, and the number of RLUs allowed to be changed to an unused state in the domain 43 is “0”. It is understood from the above that RLUs changeable to an unused state are the RLUs 153 and 154 in the domain 42. Here, the CM number of the assigned CM of the RLU 152 which has already been allocated to the allocation destination domain 41 is “0”. On the other hand, the CM number of the assigned CM of the RLU 153 is “1” and the CM number of the assigned CM of the RLU 154 is “0”. Thus, since having a common assigned CM with the RLU 152, which has already been allocated to the allocation destination domain 41, the RLU 154 is selected as an allocation candidate.

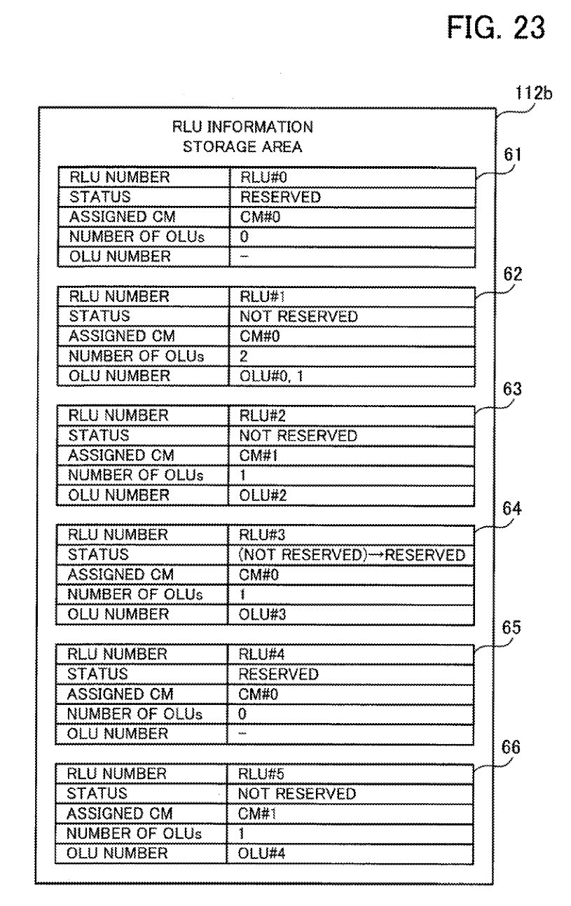

FIG. 23 illustrates an example of RLU information obtained after the selection of the third allocation candidate. According to the example of FIG. 23, because the RLU 154 with the RLU number “3” is selected as an allocation candidate, the status of the corresponding RLU information 64 is changed to “Reserved”.

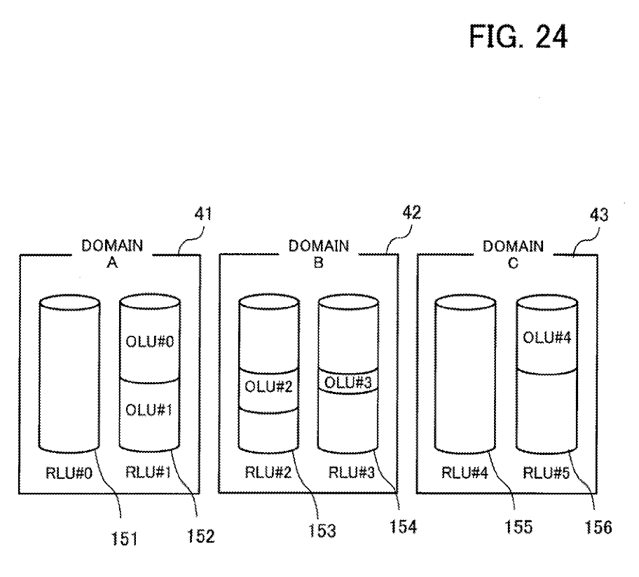

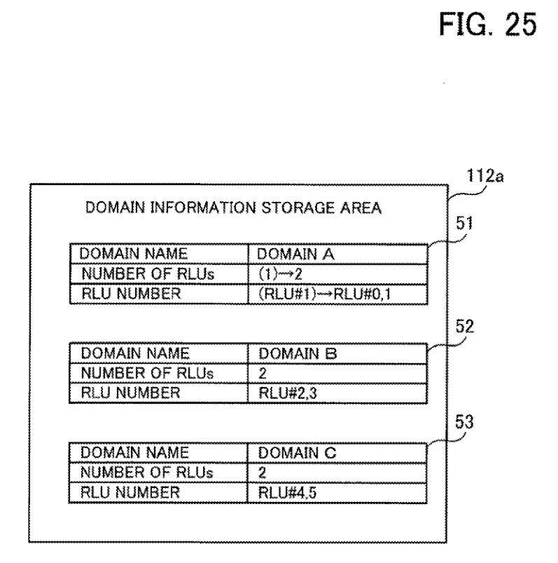

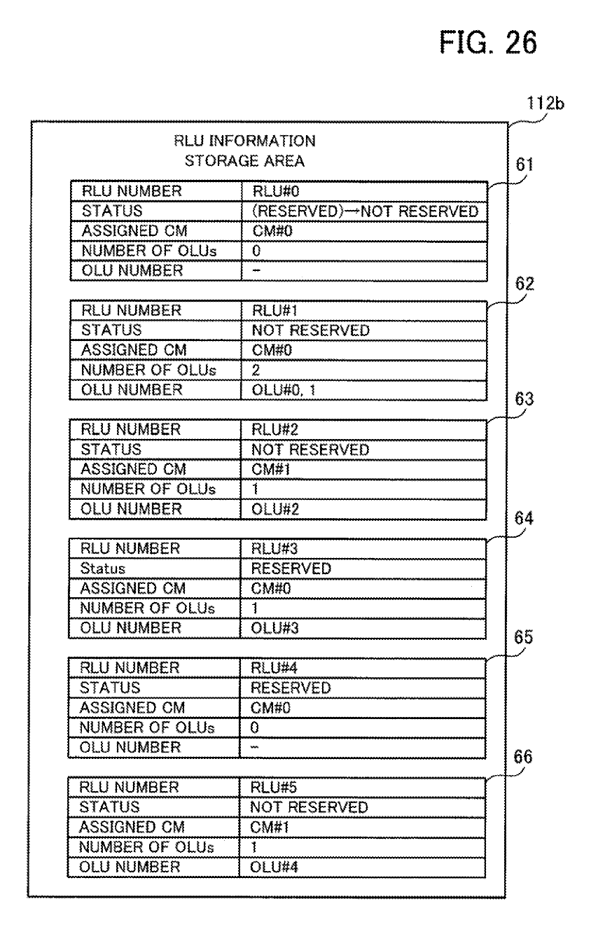

In the above-described manner, the RLUs 151, 154, and 155 as many as specified in the allocation request are selected as allocation candidates. The allocation candidate RLUs 151, 154, and 155 are sequentially selected and allocated to the allocation destination domain 41. Assume in the following example that the allocation candidate RLUs 151, 154, and 155 are selected in ascending order of the RLU numbers and allocated to the domain 41. First, the RLU 151 with the RLU number “0” is allocated to the allocation destination domain 41. FIG. 24 illustrates an example of allocating the RLU with the RLU number “0” to the allocation destination domain. The state of the RLU 151 with the RLU number “0” is changed from being unallocated to being allocated to the domain 41 with the domain name “A”. Such a change in the allocation state is achieved by updating corresponding pieces of domain and RLU information. FIG. 25 illustrates an example of domain information obtained after the allocation of the RLU with the RLU number “0” to the allocation destination domain. According to the example of FIG. 25, as for the domain information 51 with the domain name “A”, the number of RLUs has been changed from “1” to “2”, and the RLU number has been changed from “1” to “0, 1”. With this, the RLU 151 with the RLU number “0” is newly allocated to the domain 41 with the domain name “A”. FIG. 26 illustrates an example of RLU information obtained after the allocation of the RLU with the RLU number “0” to the allocation destination domain. According to the example of FIG. 26, as for the RLU information 61 with the RLU number “0”, the status has been changed from “Reserved” to “Not Reserved”.

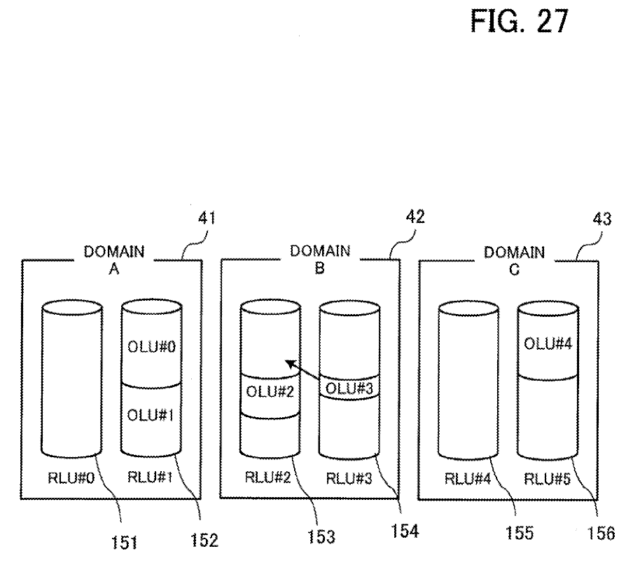

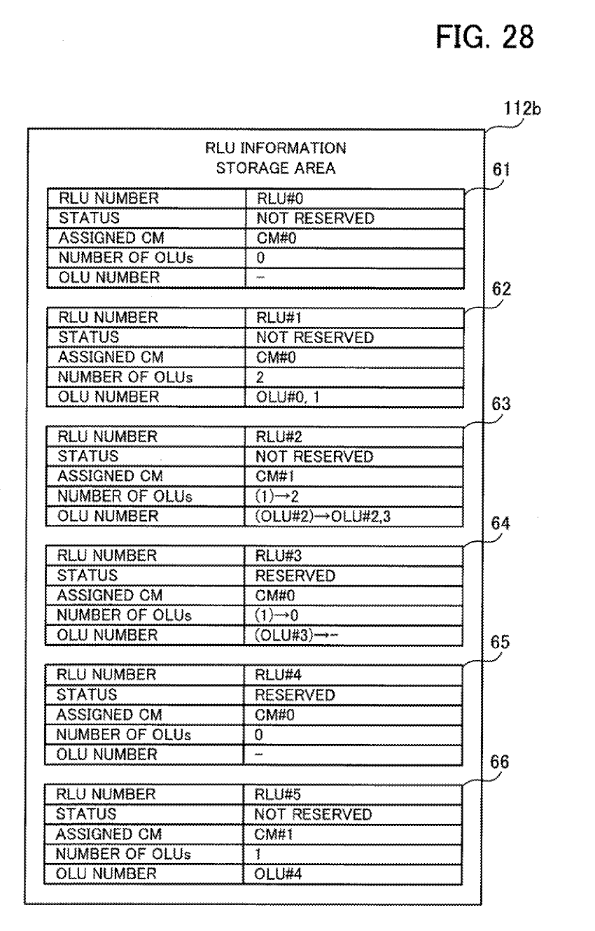

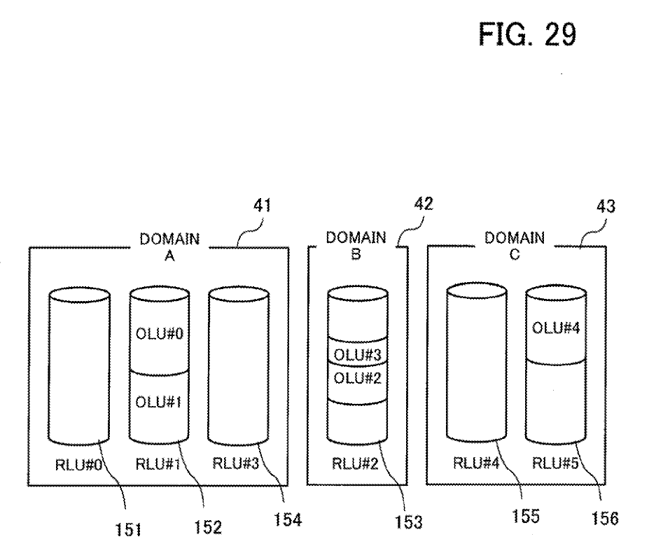

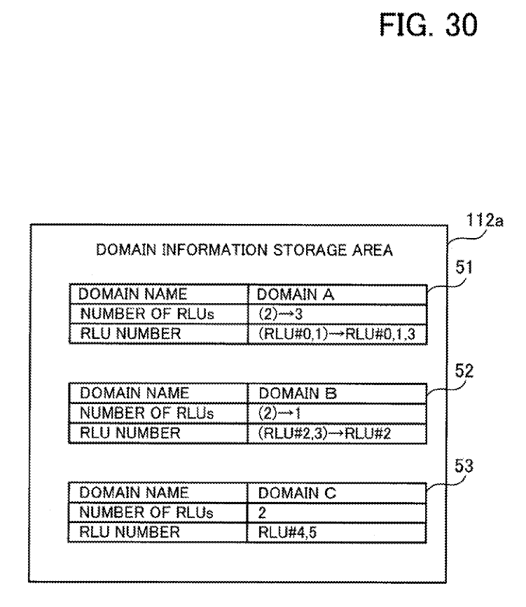

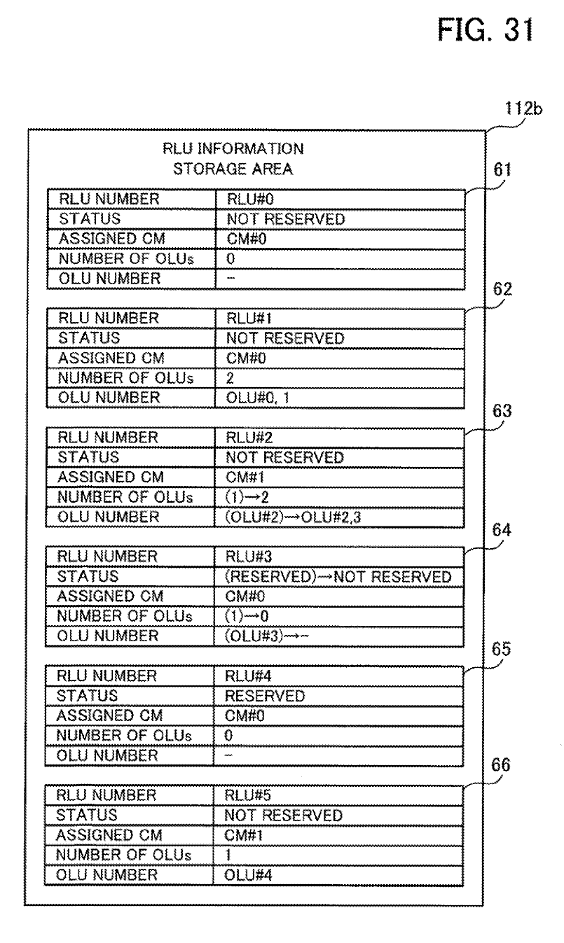

Next, the RLU 154 with the RLU number “3” is allocated to the allocation destination domain 41. Note that since the RLU 154 includes an OLU, the allocation of the RLU 154 to the domain 41 is performed after the OLU is transferred to a different RLU. FIG. 27 illustrates an example of transferring an OLU of the RLU with an RLU number “3”. An OLU (with the OLU number “3”) provided in the RLU 154 with the RLU number “3” is transferred to another RLU 153 in the same domain 42, that is, another RLU 153 having been allocated to the domain 42 to which the RLU 154 has been allocated. FIG. 28 illustrates an example of RLU information obtained after the transfer of the OLU in the RLU with the RLU number “3”. According to the example of FIG. 28, as for the RLU information 63 with the RLU number “2”, the number of OLUs has been changed from “1” to “2” and the OLU number has changed from “2” to “2, 3”. In addition, as for the RLU information 64 with the RLU number “3”, the number of OLUs has been changed from “1” to “0” and the OLU number has changed from “3” to “-”. After completion of the OLU transfer, the RLU 154 which is the transfer source is changed to be an unused state. Subsequently, the RLU 154 is allocated to the domain 41. FIG. 29 illustrates an example of allocating the RLU with the RLU number “3” to the allocation destination domain. As for the RLU 154 with the RLU number “3”, the allocation domain has been changed from the domain 42 with the domain name “B” to the domain 41 with the domain name “A”. Such a change in the allocation state is achieved by updating corresponding pieces of domain and RLU information. FIG. 30 illustrates an example of domain information obtained after the allocation of the RLU with the RLU number “3” to the allocation destination domain. According to the example of FIG. 30, as for the domain information 51 with the domain name “A”, the number of RLUs has been changed from “2” to “3”, and the RLU number has been changed from “0, 1” to “0, 1, 3”. As for the domain information 52 with the domain name “B”, the number of RLUs has been changed from “2” to “1”, and the RLU number has been changed from “2, 3” to “2”. With this, the allocation of the RLU 154 with the RLU number “3” to the domain 42 with the domain name “B” is cancelled, and the RLU 154 with the RLU number “3” is newly allocated to the domain 41 with the domain name “A”. FIG. 31 illustrates an example of RLU information obtained after the allocation of the RLU with the RLU number “3” to the allocation destination domain. According to the example of FIG. 31, as for the RLU information 63 with the RLU number “2”, the status has been changed from “Reserved” to “Not Reserved”.

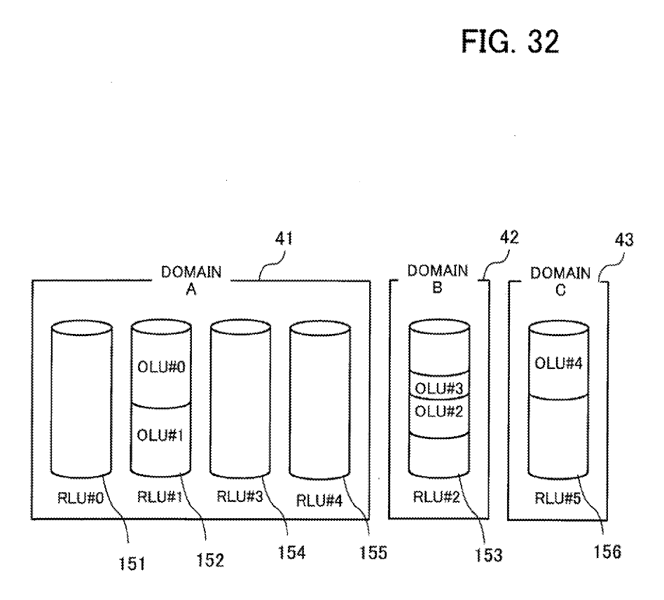

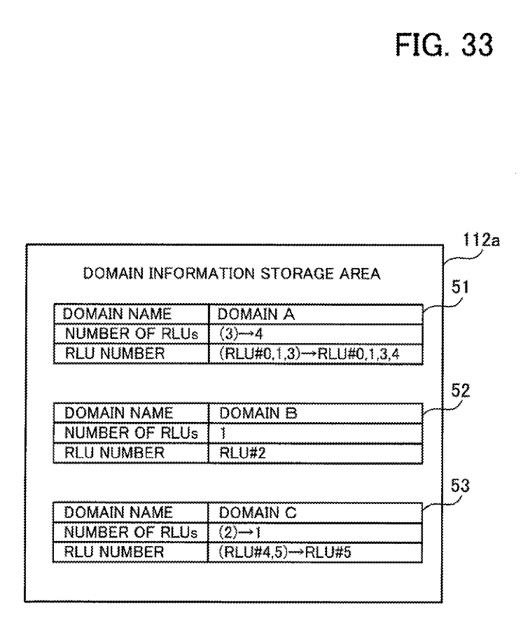

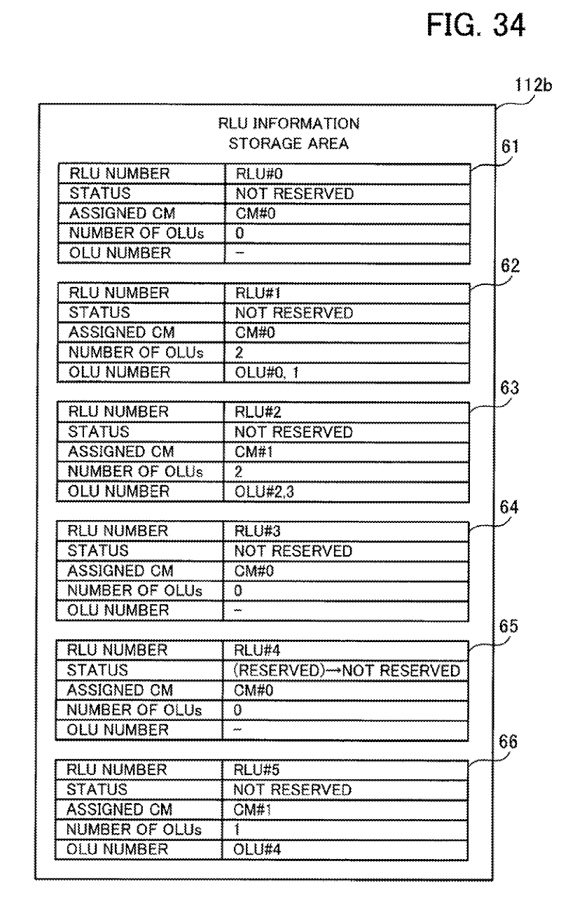

Next, the RLU 155 with the RLU number “4” is allocated to the allocation destination domain 41. FIG. 32 illustrates an example of allocating the RLU with the RLU number “4” to the allocation destination domain. As for the RLU 155 with the RLU number “4”, the allocation domain has been changed from the domain 43 with the domain name “C” to the domain 41 with the domain name “A”. Such a change in the allocation state is achieved by updating corresponding pieces of domain and RLU information. FIG. 33 illustrates an example of domain information obtained after the allocation of the RLU with the RLU number “4” to the allocation destination domain. According to the example of FIG. 33, as for the domain information 51 with the domain name “A”, the number of RLUs has been changed from “3” to “4”, and the RLU number has been changed from “0, 1” to “0, 1, 3, 4”. With this, the allocation of the RLU 155 with the RLU number “4” to the domain 43 with the domain name “C” is cancelled, and the RLU 155 with the RLU number “4” is newly allocated to the domain 41 with the domain name “A”. FIG. 34 illustrates an example of RLU information obtained after the allocation of the RLU with the RLU number “4” to the allocation destination domain. According to the example of FIG. 34, as for the RLU information 65 with the RLU number “4”, the status has been changed from “Reserved” to “Not Reserved”.

In the above described manner, automatic allocation to a domain is achieved, which results in a reduction in the number of processing operations of the overall administrator 30. In addition, according to the second embodiment, an unused RLU is detected among RLUs having already been allocated to domains and then changed to be newly allocated to a domain specified in an allocation request. With this, even in a case where there are not enough unallocated RLUs, RLU allocation to a domain can be achieved without HDD expansion. This enables more effective use of resources. Further, according to the second embodiment, in the case where no unused RLU is detected, an RLU in use is changed to an unused state and then allocated to the allocation destination domain. This further enables more effective use of resources. In addition, an RLU to be allocated to a domain is selected in such a manner that RLUs have a common assigned CM in the domain. With this, a system is achieved in which an assigned CM of each RLU to be allocated is different with respect to each domain. As a result, it is possible to prevent an I/O (input-output) access load of one domain from having an influence on I/O access performance made to another domain. Since such RLU selection is also automatically performed by the storage apparatus, it is possible to select RLUs with optimal conditions while eliminating the occurrence of errors made by the overall administrator 30 at the time of system redesigning.

Note that the allocation of each RLU to a domain can be cancelled, for example, in response to an instruction from the overall administrator 30. For example, in the case of excluding an RLU from being allocated to a domain, the overall administrator 30 inputs, into the storage apparatus 100, an allocation cancellation request which specifies an RLU number using a user interface such as the terminal 20. Subsequently, for example, by the CM 110 of the storage apparatus 100, the RLU number is deleted from a piece of domain information corresponding to a domain to which the RLU has been allocated. In addition, when information stored in the memory 112 is updated by the CM 110, the update content is reflected in the memory 122 of the CM 120 by synchronous processing between the CMs 110 and 120. This ensures uniformity of information between the memories 112 and 122. Note that each of the domain administrators 31 to 33 is able to perform operations, such as OLU creation, only on allocated RLUs specified in a piece of domain information corresponding to a domain that the domain administrator manages. Accordingly, after changes are made to form the domain information 51 to 53 as illustrated in FIG. 33, the domain administrator 31 of the domain 41 with the domain name “A”, for example, is able to operate the RLUs 151, 152, 154, and 155 with the RLU numbers “0, 1, 3, and 4”.

### [c] Other Embodiments

The second embodiment provides an example of allocating RLUs to a domain. However, the allocation objects are not limited to logical volumes like RLUs, and physical volumes such as HDDs and SSDs may be allocated.

The processing functions described in each of the above embodiments may be achieved by a computer. In this case, a program is provided in which processing contents of functions that the CMs 110 and 120 of the storage apparatus 100 need to have are described. By executing the program on the computer, the above-described processing functions are achieved on the computer. The program in which processing contents are described may be recorded in a computer-readable recording medium. Such computer-readable recording media include a magnetic-storage device, an optical disk, a magneto-optical medium, and a semiconductor memory. Examples of the magnetic-storage device are a hard disk drive (HDD), a flexible disk (FD), and a magnetic tape. Examples of the optical disk are a digital versatile disk (DVD), a digital versatile disk random access memory (DVD-RAM), a compact disc read-only memory (CD-ROM), and a CD rewritable (CD-RW). An example of the magneto-optical medium is a magneto-optical disk (MO).

In the case of distributing the program, portable recording media, such as DVDs and CD-ROMs, in which the program is recorded are sold. In addition, the program may be stored in a memory device of a server computer and then transferred from the server computer to another computer via a network.

A computer for executing the program stores the program, which is originally recorded in a portable recording medium or transferred from the server computer, in its own memory device. Subsequently, the computer reads the program from its own memory device and performs processing according to the program. Note that the computer is able to read the program directly from the portable recording medium and perform processing according to the program. In addition, the computer is able to sequentially perform processing according to a received program each time such a program is transferred from the server computer.

In addition, at least part of the above-described processing functions may be achieved by an electronic circuit, such as a digital signal processor (DSP), an application specific integrated circuit (ASIC), and a programmable logic device (PLD).

According to one aspect, it is possible to achieve resource allocation that ensures the effective use of resources.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage apparatus for managing a storage area by dividing the storage area into resources, the storage apparatus comprising:
a memory configured to store information indicating whether each of the resources having been individually allocated to one of a plurality of groups is in use; and
one or more processors configured to perform a procedure including:
in response to a resource allocation request which specifies an allocation destination group, referring to the information stored in the memory and thereby detecting an unused resource having been allocated to a group other than the allocation destination group; and
making a setting in the memory to cancel the allocation of the detected unused resource to the group other than the allocation destination group and reallocate the unused resource to the allocation destination group.

2. The storage apparatus according to claim 1, wherein
in a case where the unused resource is detected in plurality, the setting is made in the memory to
preferentially select, out of the detected unused resources, a resource controlled by a common control unit with a resource having already been allocated to the allocation destination group, and
cancel the allocation of the selected resource to the group other than the allocation destination group and reallocate the selected resource to the allocation destination group.

3. The storage apparatus according to claim 1, wherein
in a case where the unused resource is detected in plurality in different groups, the setting is made in the memory to
preferentially select a resource having been allocated to a group having a larger number of the detected unused resources, and
cancel the allocation of the selected resource to the group other than the allocation destination group and reallocate the selected resource to the allocation destination group.

4. The storage apparatus according to claim 1, wherein
in a case where the unused resource is not detected, the setting is made in the memory to
transfer data in a first resource, which has been allocated to a group other than the allocation destination group, to a second resource having been allocated to the group to which the first resource has been allocated, and
cancel the allocation of the first resource to the group other than the allocation destination group and reallocate the first resource to the allocation destination group.

5. The storage apparatus according to claim 4, wherein
the setting is made in such a manner that the first resource is, among a plurality of resources having been allocated to groups other than the allocation destination group, a resource having least used storage space.

6. The storage apparatus according to claim 1, wherein
in the resource allocation request, a condition of a resource to be allocated is specified, and
in the detection, a resource which satisfies the condition is detected among one or more unused resources having been individually allocated to groups other than the allocation destination group.

7. The storage apparatus according to claim 1, wherein
the memory stores information indicating a resource prohibited from being reallocated, and
the prohibited resource is excluded from the detection of the unused resource.

8. A storage management method executed by a storage apparatus for managing a storage area by dividing the storage area into resources, the storage management method comprising:
in response to a resource allocation request which specifies an allocation destination group, referring to information which is stored in a memory and indicates whether each of the resources individually allocated to one of a plurality of groups is in use and thereby detecting an unused resource having been allocated to a group other than the allocation destination group; and
making a setting in the memory to cancel the allocation of the detected unused resource to the group other than the allocation destination group and reallocate the unused resource to the allocation destination group.
